(19) United States
(12) Patent Application Publication
(10) Pub. No.: US 2022/0274376 A1
(43) Pub. Date: Sep. 1, 2022

(54) ADHESIVE SHEET, FLEXIBLE IMAGE DISPLAY DEVICE MEMBER, OPTICAL MEMBER, AND IMAGE DISPLAY DEVICE

(71) Applicant: Mitsubishi Chemical Corporation, Tokyo (JP)

(72) Inventors: Daiki TABATA, Tokyo (JP); Masaya MINEMOTO, Tokyo (JP)

(73) Assignee: Mitsubishi Chemical Corporation, Tokyo (JP)

(21) Appl. No.: 17/744,796

(22) Filed: May 16, 2022

Related U.S. Application Data
(63) Continuation of application No. PCT/JP2020/042515, filed on Nov. 13, 2020.

(30) Foreign Application Priority Data
Nov. 21, 2019 (JP) 2019-210797
Mar. 31, 2020 (JP) 2020-064014

(51) Int. Cl. B32B 7/12; C09J 7/38; C09J 7/10; G02B 1/18; B32B 27/08; B32B 27/28; B32B 27/38; B32B 27/36; B32B 27/40; B32B 27/30

(52) U.S. Cl. CPC B32B 7/12; C09J 7/385; C09J 7/10; G02B 1/18; B32B 27/08; B32B 27/281; B32B 27/38; B32B 27/36; B32B 27/40; B32B 27/308; C09J 2203/326; C09J 2475/00; C09J 2451/00; C09J 2433/00; B32B 2307/546; B32B 2250/02; B32B 2250/24; B32B 2307/542; B32B 2307/54; B32B 2307/748; B32B 2457/20

(57) ABSTRACT

Provided is a flexible image display device member having a configuration in which two flexible members are adhered together via a novel adhesive layer that can firmly adhere to highly polar member sheets, and has excellent bendability, wherein the adhesive layer has a maximum value of a loss tangent (tan δ) obtained by dynamic viscoelasticity measurement in a shear mode at a frequency of 1 Hz being at −20° C. or lower, and in the Hansen solubility parameters (δd, δp, and δh) on the adhesive layer surface as measured by a contact angle method, the polar term δp is 2.0 MPa^{0.5} or more and the hydrogen bond term δh is 5.0 MPa^{0.5} or more.

### TECHNICAL FIELD

The present invention relates to an adhesive sheet, a flexible image display device member, an optical member, and an image display device. More specifically, the present invention relates to an adhesive sheet suitably used for bendable image display devices, an adhesive sheet or an adhesive layer capable of firmly adhering to a member sheet or a flexible member constituting image display devices, and an optical member or a flexible image display device member using the adhesive sheet or the adhesive layer, which contributes to improving reliability of bendable image display devices.

### BACKGROUND ART

In recent years, flexible or bendable image display devices using organic light emitting diodes (OLEDs) and quantum dots (QDs) have been developed and are being widely commercialized.

Such image display devices have a structure in which plural member sheets are adhered together with transparent adhesive sheets, and there is a demand for adhesive sheets that can firmly adhere member sheets while having a softness capable of absorbing strain between member sheets due to bending.

The adhesive sheets that have been widely used in conventional image display devices have been acid-free acrylic adhesive sheets that contain substantially no acid.

Although, in recent years, there has been proposed an adhesive sheet having a low Tg (glass transition temperature) in which an acrylic polymer composition has been reviewed so as to correspond to image display devices for bending.

For example, Patent Document 1 discloses an adhesive agent containing a (meth)acrylic acid ester copolymer and a crosslinking agent, having a predetermined creep compliance value, and having improved restorability.

Patent Document 2 discloses an assembly layer for flexible devices that contains an adhesive agent composition, wherein the assembly layer has a shear storage elastic modulus of not exceeding approximately 2 MPa at a frequency of 1 Hz in a temperature range of approximately −30° C. to approximately 90° C.; a shear creep compliance (J) of at least approximately 6×10⁻⁶ l/Pa measured at 5 seconds with an applied shear stress between approximately 50 kPa and approximately 500 kPa; and a strain recovery of at least approximately 50% at at least one point of applied shear stress in a range of approximately 5 kPa to approximately 500 kPa within approximately 1 minute after releasing the applied shear stress.

Patent Document 3 discloses a flexible image display device laminate including an adhesive agent layer and an optical film including at least a polarizing film, wherein an amount of deviation based on the adhesive agent layer in an end portion of the laminate is 100 to 600 μm when the laminate is bent with a bending radius of 3 mm.

### CITATION LIST

### Patent Document

Patent Document 1: Japanese Patent Laid-Open No. 2019-123826
Patent Document 2: Japanese translation of PCT international application No. 2018-526469
Patent Document 3: International Publication No. WO 2019/026753

### SUMMARY OF THE INVENTION

### Problem to be Solved by the Invention

With the appearance of bendable image display devices, member sheets used for them that are capable of bending are also being used. For example, transparent polyimide films that are resistant to tensile stress due to bending, are hard to whiten, have high high-temperature reliability, and have excellent scratch resistance have been employed as front cover films.

Such transparent polyimide films contain a large amount of an aromatic skeleton and an imide group and/or an amide group in order to achieve both high-temperature reliability and transparency, and may contain a fluorine-based functional group depending on the type. Thus, the films are extremely high in polarity, and the adhesive sheets that have been used for conventional displays are unable to adhere firmly, resulting in a problem that the films may be peeled off due to the stress of bending or the display user may mistake the films for a part of protective films and remove them.

In addition, polarizing plate assemblies are becoming thinner and thinner. Although thin member sheets having a high polarity on the outermost surface obtained by laminating a coating-type liquid crystal layer or a TAC film (cellulose triacetate film) on the outermost surface have been introduced, such member sheets have been difficult to be firmly adhered by conventional adhesive sheets.

Furthermore, polyester-based films and epoxy-based films having improved bending resistance have been attracting attention as member sheets for bending displays.

Adhesive sheets composed of (meth)acrylic acid ester copolymers, such as those described in Patent Document 1, having a low Tg and a high degree of crosslinking are soft even at low temperatures, and have a certain degree of restorability.

However, it is therefore difficult to develop adhesive force, and it has been particularly difficult to adhere firmly to highly polar member sheets such as transparent polyimide.

When the adhesive force of adhesive sheets to member sheets is weak, defects such as delamination and foaming may occur due to folding operation or high temperature storage in a bent state, which may impair reliability of image display devices.

In addition, the demand for thinner image display devices and those with a smaller radius of curvature is expected to become more stringent every year, and along with this, the need for stronger adhesion to adhesive sheets is also increasing. With the previously known technology, adhesive sheets that can meet the requirements for bending and yet be held firmly to member sheets have not been obtained.

Thus, the present invention is intended to provide a flexible image display device member and an image display device comprising a novel adhesive sheet that can firmly adhere to member sheets having high polarity or to flexible members, and also has excellent bendability.

### Means for Solving Problem

One embodiment of the present invention is a flexible image display device member having a configuration in which two flexible members are adhered together via an adhesive layer,

wherein the adhesive layer has a maximum value of a loss tangent (tan δ) obtained by dynamic viscoelasticity measurement in a shear mode at a frequency of 1 Hz being at −20° C. or lower, and in the Hansen solubility parameters (δd, δp, and δh) on the adhesive layer surface as measured by a contact angle method, the polar term δp is 2.0 MPa^{0.5} or more and the hydrogen bond term δh is 5.0 MPa^{0.5} or more.

### Effect of the Invention

The adhesive layer exhibits a large adhesive force to highly polar member sheets or flexible members, and is also excellent in bendability. For example, even when it is folded or stored at high temperatures in a bent state, the occurrence of defects such as delamination and foaming can be suppressed. Thus, the flexible image display device member having a configuration in which two flexible members are adhered together via the adhesive layer has excellent bendability.

### MODE(S) FOR CARRYING OUT THE INVENTION

Hereafter, the present invention will be described in details. However, the contents of the present invention are not limited to the embodiments described below.

<<Present Adhesive Sheet I>>

The adhesive sheet according to an example of the embodiments of the present invention (hereinafter may be referred to as “present adhesive sheet I”) is an adhesive sheet having a maximum value of a loss tangent (tan δ) obtained by dynamic viscoelasticity measurement in a shear mode at a frequency of 1 Hz being at −20° C. or lower, in which, in the Hansen solubility parameters (δd, δp, and δh) on the adhesive sheet surface measured by a contact angle method, the polar term δp is 2.0 MPa^{0.5} or more, and the hydrogen bond term δh is 5.0 MPa^{0.5} or more.

<<Present Flexible Image Display Device Member I>>

The flexible image display device member according to an example of the embodiments of the present invention (hereinafter may be referred to as “present flexible image display device member I”) has a configuration in which two flexible members are adhered together via an adhesive layer, in which the adhesive layer (hereinafter may be referred to as “present adhesive layer I”) has a maximum value of a loss tangent (tan δ) obtained by dynamic viscoelasticity measurement in a shear mode at a frequency of 1 Hz being at −20° C. or lower, and in the Hansen solubility parameters (δd, δp, and δh) on the adhesive layer surface as measured by a contact angle method, the polar term δp is 2.0 MPa^{0.5} or more and the hydrogen bond term δh is 5.0 MPa^{0.5} or more.

The form of the present adhesive layer I is not limited. It may be formed by adhering a sheet-shaped adhesive product that is formed into a sheet shape in advance to the present flexible image display device member I, or by forming the adhesive layer directly on the present flexible image display device member I.

<Loss Tangent (Tan δ)>

In the present adhesive sheet I and the present adhesive layer I, the maximum value of the loss tangent (tan δ) obtained by dynamic viscoelasticity measurement in a shear mode at a frequency of 1 Hz is preferably at −20° C. or lower.

The maximum value thereof is more preferably at −30° C. or lower, and even more preferably at −40° C. or lower. The lower limit thereof is not particularly limited, but is generally at −70° C. or higher.

Further, in the present adhesive sheet I and the present adhesive layer I, the peak of the maximum value of the loss tangent (tan δ) in a shear mode at a frequency of 1 Hz is particularly preferably present in a temperature range of −60° C. to −20° C.

The temperature of the maximum value is a guideline for a glass transition temperature (hereinafter may be referred to as Tg) of the adhesive sheet and the present adhesive layer I. When the value is at −20° C. or lower, the storage elastic modulus at low temperatures can be sufficiently lowered to reduce the stress due to bending operations.

The elastic modulus (storage elastic modulus) G′, the viscosity (loss elastic modulus) G″, and tan δ=G″/G′ at various temperatures can be measured using a strain rheometer.

The maximum value of the loss tangent (tan δ) and the temperature of the peak of the maximum value in the present adhesive sheet I and the present adhesive layer I can be set to the above range by adjusting the type of monomers of resins constituting the present adhesive sheet I and the present adhesive layer I, the mass average molecular weight of resins, and the branching structure, as well as by adding and blending a low Tg oligomer therein.

<Storage Elastic Modulus>

In the present adhesive sheet I and the present adhesive layer I, the storage elastic modulus at −20° C. (G′(−20° C.)) is preferably 1 MPa or less, and more preferably 900 kPa or less.

When the G′(−20° C.) falls within the above range, cracking of the member sheet can be prevented.

In order to achieve the G′ (−20° C.) in the above range, the glass transition temperature (Tg) of the present adhesive sheet I and the present adhesive layer I is preferably −20° C. or lower.

The adhesive sheet and the present adhesive layer I used in the bendable image display device need to be soft at the folding speed (frequency). In order to be flexible at high frequencies, G′ is required to be low in a low temperature range by temperature-time conversion measurement of dynamic viscoelasticity, that is, the glass transition temperature (Tg) of the adhesive sheet and the present adhesive layer I is required to be low.

In the present adhesive sheet I and the present adhesive layer I, the storage shear elastic modulus at 85° C. (G′(85° C.)) obtained by dynamic viscoelasticity measurement in a shear mode at a frequency of 1 Hz is preferably 0.01 MPa or more and 0.20 MPa or less.

The storage shear elastic modulus (G′ (85° C.)) of the present adhesive sheet I and the present adhesive layer I is preferably 0.18 MPa or less, more preferably 0.15 MPa or less, and even more preferably 0.12 MPa or less. Meanwhile, the lower limit of the storage shear elastic modulus (G′ (85° C.)) is preferably 0.01 MPa or more from the viewpoint of shape maintenance.

When the storage shear elastic modulus (G′ (85° C.)) falls within the above range, for example, in forming a laminated sheet or a flexible image display device member by adhering the present adhesive sheet I or the present adhesive layer I to a member sheet or a flexible member, the interlayer stress at the time of bending of the laminated sheet or the flexible image display device member can be reduced at room temperature to high temperature, and delamination or cracking of the member sheet or the flexible member can be suppressed.

<Hansen Solubility Parameters>

The present adhesive sheet I and the present adhesive layer I preferably have a polar term δp of 2.0 MPa^{0.5} or more and a hydrogen bond term δh of 5.0 MPa^{0.5} or more in the Hansen solubility parameters (δd, δp, and δh) on the adhesive sheet surface as measured by a contact angle method.

Here, the Hansen solubility parameters (HSPs) are indicators representing the solubility how much a substance dissolves in another certain substance. The HSPs are represented in a three-dimensional space in which a solubility parameter introduced by Hildebrand is divided into three components of a dispersion term δd, a polar term δp, and a hydrogen bond term δh. The dispersion term δd represents the effect of dispersion force, the polar term δp represents the effect of dipole-dipole force, and the hydrogen bond term δh represents the effect of hydrogen bond force, and these are explained as follows (here, each unit is MPa^{0.5}.):

δd: energy derived from dispersion force between molecules;

δp: energy derived from polar force between molecules; and

δh: energy derived from hydrogen bond force between molecules.

Definitions and calculations of the HSPs are described in the following document:

Charles M. Hansen, Hansen Solubility Parameters: A Users Handbook (CRC Press, 2007).

The dispersion term reflects the van der Waals force, the polar term reflects the dipole moment, and the hydrogen bond term reflects the action of water, alcohol, and the like.

The ones whose vectors by the HSPs are similar can be determined to have high solubility, and the similarity of the vectors can be determined by the distance of the Hansen solubility parameters (HSP distance).

The Hansen solubility parameters can be indicators not only for determining the solubility, but also for determining how easily a certain substance is present in another certain substance, that is, how good the dispersion is.

In the present invention, the HSPs [δd, δp, and δh] on the surface are determined by bringing 2 μL of droplets of the various solvents with known HSPs into contact with the sheet surface, and calculating γ_{sL} from the contact angle value after 30 seconds based on the Young-Dupre equation and the Hata-Kitazaki and extended Fowkes equation, so as to correlate Rₐ and (γ_{sL}/(V_{L}^{1/3}))^{1/2} based on the relationship between the Hansen solubility parameters and the surface tension (formula 1) (Hansen Solubility Parameters 50th Anniversary Conference, preprint 2017 PP. 14-21 (2017)).

δ_{d}²+δₚ²+0.068δₕ²=13.9γ_{sL}(1/(V_{L}^{1/3})) (formula 1)

In the present adhesive sheet I and the present adhesive layer I, the polar term δp is preferably 2.0 MPa^{0.5} or more, and more preferably 3.0 MPa^{0.5} or more, in the Hansen solubility parameters (δd, δp, and δh) on the surface of the adhesive sheet or the adhesive layer. In addition, the hydrogen bond term δh is preferably 5.0 MPa^{0.5} or more, and more preferably 6.0 MPa^{0.5} or more.

When the δp and δh of the present adhesive sheet I and the present adhesive layer I fall within the above range, the wettability to highly polar member sheets such as polyimide sheets, epoxy sheets, and TAC sheets is improved, and the interfacial adhesive force is enhanced, so that the adhesive force can be improved compared to that of conventional acrylic adhesive sheets.

In order to obtain the adhesive sheet and the present adhesive layer I having such surface HSPs, it is preferable to adjust the type and the blending amount of the adhesive agent for forming the adhesive sheet, so as to expose components having high δp and δh, such as polyurethane, polyester, and polyamide, on the adhesive sheet surface.

In particular, it is preferable to use an adhesive agent containing a compound having a urethane bond.

It is also preferable to use an adhesive agent containing a graft polymer in which a polymer component such as an acrylic polymer is used as a stem component, and polyurethane, polyester, polyamide, or the like is grafted therewith as a branch component.

In particular, the method using a graft polymer is more preferable since the surface δp and δh can be effectively enhanced even when the amounts of polyurethane, polyester, and polyamide components are small.

<Gel Fraction>

The gel fraction of the present adhesive sheet I and the present adhesive layer I is preferably 55% or more, more preferably 60% or more, and even more preferably 65% or more.

When the gel fraction of the present adhesive sheet I and the present adhesive layer I is 55% or more, the shape can be sufficiently maintained.

<Urethane-Based Polymer>

A urethane-based polymer, which is representative among the polymers contained in the adhesive agent constituting the present adhesive sheet I and the present adhesive layer I, will be described below.

In the present invention, even when it is referred to as a polymer, it means encompassing both a homopolymer and a copolymer.

The urethane-based polymer is a polymer compound having a urethane bond in their molecules.

The present adhesive sheet I and the present adhesive layer I are preferably formed from an adhesive agent containing the urethane-based polymer. In particular, it is preferably formed by curing a curable composition containing the urethane-based polymer as a main component resin.

By containing the urethane-based polymer as a pre-curing component, the adhesive force and cohesive force of the present adhesive sheet I and the present adhesive layer I can be enhanced.

Here, the term “main component resin” means a resin having the largest content mass among the resins constituting the present adhesive sheet I or the present adhesive layer I. It is supposed that the main component resin occupies 50% by mass or more, 60% by mass or more, 70% by mass or more, 80% by mass or more, or 90% by mass or more (including 100% by mass) in the resins constituting the present adhesive sheet I or the present adhesive layer I.

One of the methods for producing the urethane-based polymer is a polymerization reaction between a hydroxyl group and an isocyanate.

As the hydroxyl group used as a raw material, a polyol is suitably used, and examples thereof include polyether polyols, polyester polyols, polycarbonate-based polyols, polyolefin polyols, and acrylic polyols. These compounds may be used alone or in combination of two or more thereof.

Examples of the initiator of the polyether polyols include polyethylene glycol, polypropylene glycol, polyethylene propylene glycol, polytetramethylene ether glycol, and polyhexamethylene ether glycol.

Examples of the isocyanate compound used to obtain a urethane-based polymer include aromatic diisocyanates such as tolylene diisocyanate, xylylene diisocyanate, methylene diphenyl diisocyanate, phenylene diisocyanate, naphthalene diisocyanate, and tolidine diisocyanate; aliphatic diisocyanates having an aromatic ring such as α,α,α′,α′-tetramethylxylylene diisocyanate; aliphatic diisocyanates such as methylene diisocyanate, propylene diisocyanate, lysine diisocyanate, trimethylhexamethylene diisocyanate, and hexamethylene diisocyanate; and alicyclic diisocyanates such as cyclohexane diisocyanate, methylcyclohexane diisocyanate, isophorone diisocyanate, dicyclohexylmethane diisocyanate, isopropylidene dicyclohexyl diisocyanate. These may be used alone or in combination of two or more thereof.

In the present invention, the urethane-based polymer is preferably a hydroxyl group-terminated urethane prepolymer or a graft polymer having a polymer component as a stem component and a polyurethane as a branch component.

Among them, from the viewpoint of having high bending resistance, it is preferably a graft polymer in which a stem component (main chain) composed of an acrylic polymer is bonded with a polyurethane as a branch component.

The hydroxyl group-terminated urethane prepolymer is a reaction product obtained by copolymerizing a plurality of active hydrogen group-containing compounds such as hydroxyl groups with one or more types of polyisocyanates, and the entire chain has a urethane bond.

Meanwhile, the graft polymer in which an acrylic polymer as a stem component is bonded with a polyurethane as a branch component has a urethane bond present in the branch component. In the adhesive sheet and the adhesive layer formed from this polymer, the branch component sites are concentrated on the surface. It is therefore considered that the adhesive sheet and the adhesive layer have high δp and δh on the surface.

Here, the mass average molecular weight of the acrylic polymer serving as a main chain (stem component) is, for example, 50,000 to 800,000, and the mass average molecular weight of the polyurethane site serving as a branch component is, for example, 1,000 to 20,000.

The mass average molecular weight is a value measured by using gel permeation chromatography in terms of polystyrene.

Accordingly, the present adhesive sheet I and the present adhesive layer I are preferably formed by using an adhesive agent containing a urethane polymer chain containing a molecular chain having a urethane bond (also referred to as “urethane component segment”), and an acrylic polymer chain having a molecular chain derived from a (meth)acrylic ester component (also referred to as “acrylic component segment”).

More specifically, the adhesive agent can be in the form of an adhesive agent containing any one or more polymers selected from: (a) a block polymer in which both the urethane component segment and the acrylic component segment constitute the main chain; (b) a graft polymer in which either the urethane component segment or the acrylic component segment constitutes the main chain and the other segment constitutes the side chain; (c) a crosslinked polymer in which either the urethane component segment or the acrylic component segment is crosslinked with the other segment; and (d) a polymer blend containing an acrylic polymer and a urethane-based polymer.

Further, in the above, it is preferable that the acrylic component segment and the urethane component segment are bonded by a covalent bond.

The graft polymer in which a stem component (main chain) composed of an acrylic polymer is bonded with a polyurethane as a branch component is available, for example, in the ACRIT 8BR series and ACRIT 8 HY series (both trade names of Taisei Fine Chemical Co., Ltd.).

<Other Adhesive Components>

In the present adhesive sheet I and the present adhesive layer I, the polymer contained in the adhesive agent may contain the single urethane-based polymer or two or more types of the polymers.

For example, polyester, polyamide, or an acrylic polymer may be contained in addition to the urethane-based polymer.

<Other Components>

In the present adhesive sheet I and the present adhesive layer I, other agents such as an initiator, a crosslinking agent, a tackifier, a curing accelerator, a filler, a coupling agent, an ultraviolet absorber, an ultraviolet stabilizer, an antioxidant, a stabilizer, a pigment, and a rust inhibitor, or a combination thereof may be added.

It is preferable that the amounts of these additives is typically selected so as not to adversely affect the curing of the adhesive sheet and the adhesive layer, or not to adversely affect the physical properties of the adhesive sheet and the adhesive layer.

<Surface>

It is preferable to laminate a protective film on at least one surface of the present adhesive sheet I and the present adhesive layer I from the viewpoint of preventing blocking and foreign matter adhesion. Alternatively, embossing or various unevenness (cone, pyramid shape, hemispherical shape, or the like) may be processed as necessary.

In addition, for the purpose of improving adhesion to various adherend members, various surface treatments such as corona treatment, plasma treatment, and primer treatment may be performed on the surface.

In particular, the adhesive sheet of the present invention and the present adhesive layer I may be a laminate having a mold release film laminated on at least one surface thereof. Here, as the mold release film, it is preferable to use a mold release-treated PET (polyethylene terephthalate) film from the viewpoint of light transmittance and cost.

<Total Light Transmittance and Haze>

In the present adhesive sheet I and the present adhesive layer I, the total light transmittance at a thickness of 100 μm is preferably 85% or more, more preferably 88% or more, and even more preferably 91% or more.

The haze of the present adhesive sheet I and the present adhesive layer I is preferably 1.0 or less, more preferably 0.5 or less, and particularly preferably 0.2 or less.

When the haze is 1.0 or less, the adhesive sheet or the adhesive layer can be used for display devices depending on the application.

Here, the total light transmittance is measured in accordance with Japanese Industrial Standard (JIS) K7361-1, and the haze is measured in accordance with JIS K7136.

<Thickness>

The thickness of the present adhesive sheet I and the present adhesive layer I is not particularly limited. It is preferably 0.005 mm or more, more preferably 0.01 mm or more, and even more preferably 0.15 mm or more.

Meanwhile, the upper limit is preferably 1.0 mm or less, more preferably 0.7 mm or less, and even more preferably 0.5 mm or less.

When the thickness is 0.005 mm or more, the handleability is good, and when the thickness is 1.0 mm or less, it is possible to contribute to thinning of laminates.

<Preferred Applications of Present Adhesive Sheet I>

The present adhesive sheet I is preferably used for adhering a member constituting a display member (also referred to as “display member”), especially for adhering a flexible member for displays used for producing displays, and is particularly preferred for use as an adhesive component for flexible displays used for producing flexible displays.

As to the flexible member, the same flexible member as described later can be used.

<Constituent Element of Present Flexible Image Display Device Member I>

Next, elements other than the present adhesive layer I among the constituent elements of the present flexible image display device member I will be described.

<Flexible Member>

Examples of the flexible member constituting the present flexible image display device member I include flexible displays such as an organic electroluminescence (EL) display; and flexible members for displays such as a cover lens (cover film), a polarizing plate, a polarizer, a retardation film, a barrier film, a viewing angle compensation film, a luminance-improving film, a contrast-improving film, a diffusion film, a semi-transmissive reflective film, an electrode film, a transparent conductive film, a metal mesh film, and a touch sensor film. Any one or two types of these may be used in combination. For example, a combination of a flexible display and one other type of flexible member, or a combination of a cover lens and one other type of flexible member can be cited.

Here, the flexible member means a member capable of being bent, and particularly a member capable of being bent repeatedly. In particular, it is preferably a member capable of being fixed in a curved shape having a bending radius of 25 mm or more, especially a member capable of withstanding repeated bending actions at a bending radius of less than 25 mm, and more preferably less than 3 mm.

The adhesive force between the flexible member and the adhesive layer is usually determined by the viscoelastic element such as the magnitude of the loss elastic modulus (G″) at a peeling frequency (speed), and the interfacial adhesive force element such as wetting.

However, the adhesive layer having a low Tg for bending may not be expected to be significantly improved due to restrictions on viscoelasticity, and it has been found that the HSPs on the adhesive layer surface are likely to contribute to the improvement of the interfacial adhesive force.

Therefore, the HSP distance (Ra) between the Hansen solubility parameters on the flexible member surface and the Hansen solubility parameters on the present adhesive layer I surface is preferably 17.0 or less, more preferably 16.0 or less, and even more preferably 15.0 or less.

Here, the HSP distance (Ra) is calculated by the following formula 2.

HSP distance (Ra)={4×(δd_{A}−δd_{S})²+(δp_{A}−δp_{S})²+(δh_{A}−δh_{S})²}^{0.5} (formula 2)

In the formula 2, δd_{A}, δ p_{A}, and δh_{A} represent δd, δp, and δh of the present adhesive layer I, respectively; and δd_{S}, δp_{S}, and δh_{S} represent δd, δp, and δh of the flexible member, respectively.

When the HSP distance (Ra) falls within the above range, the adhesive force between the flexible member and the present adhesive layer I can be sufficiently enhanced. There are various methods for evaluating the adhesive force. For example, in the present adhesive layer I, the 180 degree peel strength at a peel speed of 300 mm/min at 60° C. (JIS Z 0237) can be 10.0 N/25 mm or more, and more preferably 11.0 N/25 mm or more, with respect to a flexible member, especially to a flexible member composed of a highly polar film.

When the adhesive force between the flexible member and the present adhesive layer I falls within the above range, the reliability of the image display device can be improved without peeling off the member sheet due to stress during bending.

In order to set the HSP distance in the above range, for example, the δp and δh on the present adhesive layer I may be increased, or a primer having HSPs close to the HSPs on the present adhesive layer I may be coated on the flexible member side.

However, it is not limited to these methods.

<<Present Optical Member I>>

The optical member according to an example of the embodiments of the present invention (hereinafter may be referred to as “present optical member I”) is a laminate having a member sheet on at least one surface of the present adhesive sheet I or the present adhesive layer I described above.

The present optical member I may be a laminated sheet having a configuration in which a member sheet (hereinafter may be referred to as “first member sheet”), the present adhesive sheet I or the present adhesive layer I, and optionally a member sheet (hereinafter may be referred to as “second member sheet”) are laminated in this order.

In this case, the first member sheet and the second member sheet may be the same or may be different.

<Member Sheet>

Examples of the main component resin of the member sheet to be the adherend of the present adhesive sheet I or the present adhesive layer I include polycycloolefin, cellulose triacetate resin, polymethyl methacrylate, polyester, epoxy resin, and polyimide; and one or two or more types of these resins may be used.

Here, the term “main component resin” refers to a component occupying the largest mass ratio among the resins constituting the member sheet or the resin composition forming the member sheet. Specifically, it occupies 50% by mass or more, preferably 55% by mass or more, and more preferably 60% by mass or more in the member sheet or the resin composition forming the member sheet.

The member sheet may be a thin film glass. Here, the thin film glass refers to a glass having a thickness of the member sheet described above.

Among them, a member sheet containing one or two or more resins selected from the group consisting of polyimide, epoxy resin, and polyester as the main component resin has particularly high polar, but the effect can be particularly found since the present adhesive sheet I or the present adhesive layer I has high δp and δh.

Among them, a polyimide film containing polyimide as the main component is suitably used as a member sheet for flexible displays since it has a high Tg, a low linear expansion coefficient, excellent high-temperature reliability, high tensile strength, and is unlikely to cause whitening due to bending.

Ordinary polyimide is often brown in color, but a transparent polyimide film in which the chemical structures of the diamine component and the dicarboxylic acid component are appropriately selected and the band gap is adjusted, is particularly preferable.

<Thickness of Optical Member>

The thickness of the present optical member I is not particularly limited. As an example of the case where the present optical member I is used in an image display device, the optical member I may have a sheet shape. When the thickness is 0.01 mm or more, the handleability is good, and when the thickness is 1.0 mm or less, it is possible to contribute to thinning of laminates.

Accordingly, the thickness of the present optical material I is preferably 0.01 mm or more, more preferably 0.03 mm or more, and particularly preferably 0.05 mm or more. Meanwhile, the upper limit is preferably 1.0 mm or less, more preferably 0.7 mm or less, and particularly preferably 0.5 mm or less.

<HSP Distance (Ra)>

The adhesive force between the member sheet and the adhesive sheet or the adhesive layer is usually determined by the viscoelastic element such as the magnitude of the loss elastic modulus (G″) at a peeling frequency (speed), and the interfacial adhesive force element such as wetting.

However, the adhesive sheet or the adhesive layer having a low Tg for bending may not be expected to be significantly improved due to restrictions on viscoelasticity, and it has been found that the HSPs on the adhesive agent surface are likely to contribute to the improvement of the interfacial adhesive force.

Therefore, in the present optical member I, the HSP distance (Ra) between the Hansen solubility parameters on the member sheet surface and the Hansen solubility parameters on the surface of the present adhesive sheet I or the present adhesive layer I is preferably 17.0 or less, more preferably 16.0 or less, and even more preferably 15.0 or less.

Here, the HSP distance (Ra) is calculated by the following formula 2.

HSP distance (Ra)={4×(δd_{A}−δd_{S})²+(δp_{A}−δp_{S})²+(δh_{A}−δh_{S})²}^{0.5} (formula 2)

In the formula 2, δd_{A}, δp_{A}, and δh_{A} represent δd, δp, and δh of the present adhesive sheet I, respectively; and δd_{S}, δp_{S}, and δh_{S} represent δd, δp, and δh of the present member sheet, respectively.

When the HSP distance (Ra) falls within the above range, the adhesive force between the member sheet and the present adhesive sheet I or the present adhesive layer I can be sufficiently enhanced.

There are various methods for evaluating the adhesive force. For example, in the present adhesive sheet I or the present adhesive layer I, the 180 degree peel strength at a peel speed of 300 mm/min at 60° C. (JIS Z 0237) can be 10.0 N/25 mm or more, and more preferably 11.0 N/25 mm or more, with respect to a member sheet, especially to a member sheet composed of a highly polar film.

When the adhesive force between the member sheet and the present adhesive sheet I or the present adhesive layer I falls within the above range, the reliability of the image display device can be improved without peeling off the member sheet due to stress during bending.

In order to set the HSP distance in the above range, for example, the δp and δh on the adhesive sheet or the present adhesive layer I may be increased, or a primer having HSPs close to the HSPs on the adhesive sheet or the present adhesive layer I may be coated on the member sheet side.

However, it is not limited to these methods.

<<Methods for Producing Present Adhesive Sheet I, Present Adhesive Layer I, and Present Optical Member I>>

Next, the methods for producing the present adhesive sheet I, the present adhesive layer I, and the present optical member I will be described. However, the following description is an example of the methods for producing the present adhesive sheet I, the present adhesive layer I, and the present optical member I. The present adhesive sheet I, the present adhesive layer I, and the present optical member I are not limited to those produced by such producing methods.

In the production of the present adhesive sheet I, an adhesive agent resin composition for forming the present adhesive sheet I (also referred to as “present adhesive layer I-forming resin composition”), which contains, for example, a urethane-based polymer, and optionally, an acrylic monomer, an acrylic polymer, an olefin-based monomer, an olefin-based polymer, a tackifier, an initiator, a crosslinking agent, and other components, is prepared.

Then, the adhesive agent resin composition may be formed into a sheet shape, subjected to a crosslinking reaction to be cured, and appropriately processed if necessary, to thereby produce the present adhesive sheet I.

However, it is not limited to this method.

In the production of the present adhesive layer I, the present adhesive layer I-forming resin composition is prepared in the same manner as described above to coat on a member sheet or a flexible member, and the resin composition may be cured to form the present adhesive layer I.

Then, the present adhesive sheet I or the present adhesive layer I may be adhered to the first member sheet or the second member sheet to produce the present optical member I.

However, it is not limited to such a production method.

In preparing the adhesive agent resin composition for forming the present adhesive sheet I or the present adhesive layer I, the above raw materials may be kneaded using a temperature-controllable kneader (for example, a disperser, a single-screw extruder, a twin-screw extruder, a planetary mixer, a twin-screw mixer, and a pressure kneader).

In mixing various raw materials, various additives such as a silane coupling agent and an antioxidant may be blended with the resin in advance, and then supplied to the kneader; or all the materials are melt-mixed in advance, and then supplied thereto; or a master batch in which only the additives are concentrated in the resin in advance may be prepared, and supplied thereto.

(Initiator)

In order to impart curability to the present adhesive sheet I or the present adhesive layer I, it is preferable to cure, in other words, crosslink the adhesive agent resin composition for forming the present adhesive sheet I or the present adhesive layer I, as described above.

In this case, the adhesive agent resin composition for forming the present adhesive sheet I or the present adhesive layer I may be coated on the first member sheet or the second member sheet and crosslinked, or the adhesive agent resin composition for forming the present adhesive sheet I or the present adhesive layer I may be crosslinked to be adhered thereon.

In order to cure the adhesive agent resin composition for forming the present adhesive sheet I or the present adhesive layer I, the adhesive agent resin composition for forming the adhesive sheet I or the adhesive layer I preferably contains an initiator or a crosslinking agent.

The initiator is not particularly limited. For example, those activated by heat, and those activated by active energy rays can be both used. In addition, those that generate radicals and cause radical reactions, and those that generate cations and anions and cause addition reactions can be both used.

Preferred initiators are radical initiators, especially photoradical initiators.

Preferred examples of the photoradical initiator include compounds that generate active radical species by being irradiated with light such as ultraviolet rays or visible light, more specifically, light having a wavelength of 200 to 780 nm.

As the photoradical initiator, either a cleavage-type photoinitiator or a hydrogen abstraction-type photoinitiator can be used, or both can be used in combination.

Examples of the cleavage-type photoinitiator include 2,2-dimethoxy-1,2-diphenylethane-1-one, 1-hydroxycyclohexyl phenyl ketone, 2-hydroxy-2-methyl-1-phenyl-propane-1-one, 1-(4-(2-hydroxyethoxy)phenyl)-2-hydroxy-2-methyl-1-propane-1-one, 2-hydroxy-1-[4-{4-(2-hydroxy-2-methyl-propionyl)benzyl}phenyl]-2-methyl-propane-1-one, oligo(2-hydroxy-2-methyl-1-(4-(1-methylvinyl)phenyl)propanone), methyl phenylglyoxylic acid, 2-benzyl-2-dimethylamino-1-(4-morpholinophenyl)butane-1-one, 2-methyl-1-[4-(methylthio)phenyl]-2-morpholinopropane-1-one, 2-(dimethylamino)-2-[(4-methylphenyl)methyl]-1-[4-(4-morpholinyl)phenyl]-1-butanone, bis(2,4,6-trimethylbenzoyl)-phenylphosphine oxide, 2,4,6-trimethylbenzoyldiphenylphosphine oxide, (2,4,6-trimethylbenzoyl)ethoxyphenylphosphine oxide, bis(2,6-dimethoxybenzoyl)2,4,4-trimethylpentylphosphine oxide, and any derivative thereof.

The use of the cleavage-type photoinitiator is preferred since the photoinitiator is structurally changed and deactivated after completing the photoreaction, resulting in that the photoinitiator does not remain as an active species in the adhesive agent resin composition after completing the curing reaction, and there is no possibility of causing unexpected photodegradation or the like in the adhesive agent resin composition.

Examples of the hydrogen abstraction-type photoinitiator include benzophenone, 4-methyl-benzophenone, 2,4,6-trimethylbenzophenone, 4-phenylbenzophenone, 3,3′-dimethyl-4-methoxybenzophenone, 4-(meth)acryloyloxybenzophenone, methyl 2-benzoylbenzoate, methyl benzoylformate, bis(2-phenyl-2-oxoacetic acid)oxy-bis-ethylene, 4-(1,3-acryloyl-1,4,7,10,13-penta-oxo-tridecyl)benzophenone, thioxanthone, 2-chlorothioxanthone, 3-methylthioxanthone, 2,4-dimethylthioxanthone, 2-methylanthraquinone, 2-ethylanthraquinone, 2-tert-butylanthraquinone, 2-aminoanthraquinone, and any derivative thereof.

The use of the hydrogen abstraction-type photoinitiator is preferred since the photoinitiator can also undergo a hydrogen abstraction reaction with various sites of the polymer, allowing a more complicated crosslinked structure to be formed.

The hydrogen abstraction-type photoinitiator is also preferred since it can function as an active species repeatedly by re-irradiating light even after being used for a photocuring reaction once, and thus, when the adhesive agent resin composition is used as a so-called post-curing type as described later, it can serve as a starting point for the photo-reaction at the time of post-curing.

In particular, in the present invention, when the above-mentioned graft polymer in which the stem component (main chain) composed of an acrylic polymer is bonded with a polyurethane as the branch component is subjected to a photocuring reaction using a hydrogen abstraction-type photoinitiator, the adhesive sheet or the adhesive layer having high bending resistance to highly polar member sheets can be obtained.

Therefore, the present adhesive sheet I or the present adhesive layer I preferably contains a hydrogen abstraction-type initiator.

Meanwhile, a thermal initiator can be used for forming a crosslinked structure in addition to the photoinitiator.

Examples of the thermal initiator include azo compounds, quinines, nitro compounds, acyl halides, hydrazones, mercapto compounds, pyrylium compounds, imidazoles, chlorotriazines, benzoins, benzoin alkyl ethers, diketones, phenones, dilauroyl peroxides, and organic peroxides such as 1,1-di(t-hexylperoxy)-3,3,5-trimethylcyclohexane, available as PERHEXA TMH (NOF Corp.).

(Crosslinking Agent)

Further, a crosslinking agent such as a polyfunctional (meth)acrylate can be used for forming a crosslinked structure. When the crosslinking agent is a high molecular weight component containing an active hydrogen group such as a hydroxyl group, it can be crosslinked by isocyanate, carbodiimide, or the like. Among these, isocyanate is preferred, and isocyanates described in the polyurethane section can be suitably used.

It is particularly preferable to use a crosslinking agent especially for the above-mentioned hydroxyl group-terminated urethane prepolymer.

It is also preferable to further add a transition metal catalyst or the like to promote the crosslinking reaction for the process of forming the adhesive sheet or the adhesive layer.

The crosslinking agent is often used at a concentration of 0.01% by mass to 10% by mass, or 0.01% by mass to 5% by mass, based on the total mass of the present adhesive sheet I or the present adhesive layer I. A mixture composed of a plurality of crosslinking agents may be used.

(Tackifier)

The adhesive agent resin composition for forming the present adhesive sheet I or the present adhesive layer I, or the present adhesive sheet I or the present adhesive layer I may contain a tackifier as necessary. In general, the tackifier may be an arbitrary compound or a mixture of compounds that enhances the adhesiveness of the adhesive agent composition.

The tackifier is not particularly limited, and conventionally known ones can be used. Examples thereof include terpene-based tackifiers, phenol-based tackifiers, rosin-based tackifiers, aliphatic-based petroleum resins, aromatic-based petroleum resins, copolymer-based petroleum resins, alicyclic-based petroleum resins, xylene resins, epoxy-based tackifiers, polyamide-based tackifiers, ketone-based tackifiers, and elastomer-based tackifiers; and these may be used alone or in combination of two or more types of these.

(Curing Accelerator)

The adhesive agent resin composition for forming the present adhesive sheet I or the present adhesive layer I, or the present adhesive sheet I or the present adhesive layer I may contain a curing accelerator as necessary.

A conventionally known curing accelerator can be added in order to promote the curing reaction of the adhesive agent resin composition for forming the present adhesive sheet I or the present adhesive layer I.

(Molding)

Examples of the method for molding the adhesive agent resin composition for forming the present adhesive sheet I into a sheet shape include known methods, such as a wet laminating method, a dry laminating method, an extrusion casting method using a T-die, an extrusion laminating method, a calender method, an inflation method, an injection molding method, and a liquid injection curing method. Among them, a wet laminating method, an extrusion casting method, and an extrusion laminating method are preferred for producing sheets.

(Curing)

When the adhesive agent resin composition for forming the present adhesive sheet I or the present adhesive layer I contains an initiator, a cured product can be produced by irradiating with heat and/or active energy rays for curing.

In particular, the present adhesive sheet I can be produced by irradiating a molded body of the adhesive agent resin composition for forming the present adhesive sheet I or the present adhesive layer I with heat and/or active energy rays.

Examples of the active energy rays to be irradiated include ionizing radiation such as α-rays, β-rays, γ-rays, neutron rays, and electron beams; ultraviolet rays; and visible rays. Among them, ultraviolet rays are preferred from the viewpoint of suppressing damage to optical device constituent members and of the reaction control.

The irradiation energy, irradiation time, and irradiation method of the active energy rays are not particularly limited as long as the monomer component can be polymerized by activating the initiator.

<Another Production Method>

As another embodiment of the method for producing the present adhesive sheet I, the above-mentioned adhesive agent resin composition for forming the present adhesive sheet I may be dissolved in an appropriate solvent, and various coating methods may be applied.

In the case of using the coating method, the present adhesive sheet I can also be obtained by heat-curing in addition to the above-mentioned active energy ray irradiation curing.

In the case of using the coating method, the thickness of the adhesive sheet can be adjusted by the coating thickness and the solid content concentration of the coating liquid.

From the viewpoint of preventing blocking and foreign material adhesion, a protective film on which a mold release layer is laminated can be provided on at least one surface of the present adhesive sheet I or the present adhesive layer I.

Alternatively, embossing or various unevenness (cone, pyramid shape, hemispherical shape, or the like) may be processed as necessary.

In addition, for the purpose of improving adhesion to various member sheets, various surface treatments such as corona treatment, plasma treatment, and primer treatment may be performed on the surface.

<<Method for Producing Present Flexible Image Display Device Member I>>

The method for producing the present flexible image display device member I is not particularly limited. As described above, it may be formed by coating the resin composition for forming the present adhesive layer I on the flexible member, or by molding the resin composition into a sheet shape in advance and then adhering to the flexible member.

<<Present Image Display Device I>>

By incorporating the present optical member I, for example, by laminating the present optical member I on another image display device constituent member, an image display device provided with the present optical member I (also referred to as “present image display device I”) can be formed.

In particular, the present optical member I prevents delamination and cracking of the laminated sheet even when it is folded under low and high temperature environments, and has good restorability, thereby capable of forming a flexible image display device.

Here, the flexible image display device refers, more specifically, to an image display device composed of a member capable of being fixed in a curved shape having a bending radius of 25 mm or more, and particularly to a member capable of withstanding repeated bending actions at a bending radius of less than 25 mm, and more preferably less than 3 mm.

Examples of the other image display device constituent members include optical films such as a polarizing film and a retardation film as described above, and flexible members such as a liquid crystal material and a backlight panel.

<<Present Adhesive Sheet II>>

The adhesive sheet according to an example of the embodiments of the present invention (hereinafter referred to as “present adhesive sheet II”) contains an adhesive agent (hereinafter referred to as “present adhesive agent II”) having a urethane polymer chain containing a molecular chain having a urethane bond derived from a polyether polyol component and an isocyanate component (hereinafter referred to as “urethane component segment”), and an acrylic polymer chain containing a molecular chain derived from a (meth)acrylic acid alkyl ester component (hereinafter referred to as “acrylic component segment”).

<<Present Flexible Image Display Device Member II>>

The flexible image display device member according to an example of the embodiments of the present invention (hereinafter may be referred to as “present flexible image display device member II”) is a flexible image display device member having a configuration in which two flexible members are adhered together via an adhesive layer, wherein the adhesive layer (hereinafter may be referred to as “present adhesive layer II”) contains the present adhesive agent II.

The form of the present adhesive layer II is not limited. It may be formed by adhering a sheet-shaped adhesive product that is formed into a sheet shape in advance to the present flexible image display device member II, or by forming the adhesive layer directly on the present flexible image display device member II.

The acrylic component segment, that is, the “acrylic polymer chain containing a molecular chain derived from a (meth)acrylic acid alkyl ester component” means a molecular chain structure in which a (meth)acrylic acid alkyl ester is continuously polymerized, and the acrylic component segment is a segment having the molecular chain structure.

Meanwhile, the urethane component segment, that is, the “urethane polymer chain containing a molecular chain having a urethane bond derived from a polyether polyol component and an isocyanate component” means a molecular chain structure in which a urethane bond is formed by a reaction between polyether polyol and polyisocyanate, and the urethane component segment is a segment having the molecular chain structure.

<Present Adhesive Agent II>

When the present adhesive agent II contains a urethane component segment, the δp on the surface HSPs can be increased compared to that of the adhesive sheet or the adhesive layer composed of only an acrylic polymer, as described later. Accordingly, the wettability with various display films (member sheets) having a large δp is improved, and the interfacial adhesive force is improved, which consequently contributes to the improvement of the adhesive force in the peeling test.

In the present adhesive sheet II or the present adhesive layer II, the mass ratio of the acrylic component segment is preferably larger than that of the urethane component segment in the present adhesive agent II. Above all, the mass of the urethane component segment is preferably 0.3 to 40 parts by mass, more preferably 0.5 part by mass or more or 30 parts by mass or less, and even more preferably 1 part by mass or more or 20 parts by mass or less, relative to 100 parts by mass of the acrylic component segment.

As the urethane component segment, those having a polyether chain, a polyester chain, and a polycarbonate chain can be generally cited.

However, in the present invention, a polyether-type urethane component segment having a polyether chain is preferred from the viewpoint of compatibility with an acrylic component.

The urethane component segment is formed from a polyol and a polyfunctional isocyanate compound, and the polyol is preferably a polyether polyol.

Furthermore, among the polyether polyols, it is preferable to select those containing a component derived from polyether glycol, especially those containing polyether glycol as a main component.

Here, the term “main component” means a component having the highest mass ratio in the polyol; and it preferably occupies 50% by mass or more, more preferably 70% by mass or more, even more preferably 80% by mass or more, and still more preferably 90% by mass or more (including 100% by mass) in the polyol.

In the present adhesive sheet II or the present adhesive layer II, it is preferable that the acrylic component segment and the urethane component segment in the present adhesive agent II are bonded by a covalent bond.

The present adhesive agent II preferably contains one or more types of the following polymers (a) to (c).

Further, it is preferable that the acrylic component segment and the urethane component segment are bonded by a covalent bond. By containing a polymer in which the acrylic component segment and the urethane component segment are bonded by a covalent bond, the acrylic component segment and the urethane component segment are easily compatible with each other, and the transparency of the present adhesive sheet II or the present adhesive layer II is improved.

(a) A block polymer in which both the urethane component segment and the acrylic component segment constitute the main chain

(b) A graft polymer in which either the urethane component segment or the acrylic component segment constitutes the main chain, and the other segment constitutes the side chain

(c) A crosslinked polymer in which either the urethane component segment or the acrylic component segment is crosslinked with the other segment

### First Embodiment

Among the above, as a preferred embodiment of the present adhesive sheet II or the present adhesive layer II (hereinafter referred to as “first embodiment”), an embodiment in which the present adhesive agent II contains a graft polymer having a stem polymer composed of an acrylic polymer and a branch polymer composed of a polyether-type polyurethane (also referred to as “graft chain”) as a main component resin, can be cited.

Here, the term “main component resin” means a resin having the highest mass ratio in the resins constituting the present adhesive agent II; and it preferably occupies 50% by mass or more, more preferably 70% by mass or more, even more preferably 80% by mass or more, and still more preferably 90% by mass or more (including 100% by mass) in the resins constituting the present adhesive agent II.

It is more preferable that a graft copolymer having the urethane component segment as a branch polymer is used as the main component resin, since the Hansen solubility parameters (δp and δh: details are described below) on the surface can be efficiently enhanced even when the amount of the polyurethane component is small.

Here, the polyether-type polyurethane refers to a polyurethane having a plurality of molecular chains having a urethane bond derived from a polyether polyol component. The details will be described below.

The polyurethane of the branch polymer is preferably a (meth)acryloyl group-terminated polyurethane from the viewpoint of enhancing compatibility with an acrylic polymer and restorability after extension.

That is, it is preferably a graft polymer in which the main chain composed of an acrylic polymer is bonded with a (meth)acryloyl group-terminated polyurethane as a branch component.

This graft polymer has an acrylic component segment and a urethane component segment in the polymer alone.

The (meth)acryloyl group-terminated polyurethane is preferably a polyurethane having a hydroxyl group-containing acrylate added to the terminal of the polyurethane. Such a polyurethane is available under the trade name of UKW series of Taisei Fine Chemical Co., Ltd.

The graft polymer in which an acrylic polymer as a stem component is bonded with a polyurethane as a branch component exposes the polyurethane to the surface of the adhesive sheet, thereby obtaining an adhesive sheet having high δp and δh on the surface HSPs.

The mass average molecular weight of the acrylic polymer as the main chain is preferably, for example, 50,000 to 1,300,000, and the mass average molecular weight of the polyurethane site as the branch component is preferably, for example, 1,000 to 20,000.

Here, the mass average molecular weight is a value measured by using gel permeation chromatography in terms of polystyrene.

In the first embodiment, the present adhesive agent II can also be formed from an adhesive agent composition containing an initiator and/or a crosslinking agent, other resin components, and additives, in addition to the polymers (a) to (c).

Among them, the adhesive agent composition is preferably a photo- or heat-curable adhesive agent composition, and in that case, an initiator and/or a crosslinking agent is often contained therein.

(Initiator)

The initiator is not particularly limited. For example, those activated by heat, and those activated by active energy rays can be both used.

In addition, those that generate radicals and cause radical reactions, and those that generate cations and anions and cause addition reactions can be both used.

Specific examples thereof include organic peroxides and azo compounds.

Examples of the organic peroxides include lauroyl peroxide, 1,1-bis(t-hexylperoxy)-3,3,5-trimethylcyclohexane, t-hexylperoxypivalate, t-butylperoxypivalate, 2,5-dimethyl-2,5-bis(2-ethylhexanoylperoxy)hexane, t-hexylperoxy-2-ethylhexanoate, t-butylperoxy-2-ethylhexanoate, t-butylperoxyisobutyrate, t-butylperoxy-3,5,5-trimethylhexanoate, and t-butylperoxylaurate.

Examples of the azo compounds include azobisisobutyronitrile and azobiscyclohexanecarbonitrile. These initiators may be used alone or in combination of two or more thereof.

In addition to the above, preferred examples thereof include a compound (so-called photoinitiator) that generates active radical species by being irradiated with light such as ultraviolet rays or visible rays, more specifically, light having a wavelength of 200 to 780 nm.

As the photoinitiator, either a cleavage-type photoinitiator or a hydrogen abstraction-type photoinitiator can be used, or both can be used in combination.

Examples of the cleavage-type photoinitiator include the same compounds as those in the present adhesive sheet I or the present adhesive layer I as described above.

The use of the cleavage-type photoinitiator is preferred since the photoinitiator is structurally changed and deactivated after completing the photoreaction, resulting in that the photoinitiator does not remain as an active species after completing the curing reaction, and there is no possibility of causing unexpected photodegradation or the like.

Examples of the hydrogen abstraction-type photoinitiator include the same compounds as those in the present adhesive sheet I or the present adhesive layer I as described above.

The use of the hydrogen abstraction-type photoinitiator is preferred since the photoinitiator can also undergo a hydrogen abstraction reaction with various sites of the polymer, allowing a more complicated crosslinked structure to be formed.

The hydrogen abstraction-type photoinitiator is also preferred since it can function as an active species repeatedly by re-irradiating light even after being used for a photocuring reaction once.

In particular, in the present invention, when the above-mentioned polymer in which the main chain composed of an acrylic polymer is bonded with a polyurethane as the branch component is subjected to a photocuring reaction using a hydrogen abstraction-type photoinitiator, the adhesive sheet or the adhesive layer having high bending resistance to highly polar member sheets can be obtained.

In addition to the photoinitiator, a thermal polymerization initiator can be used for forming a crosslinked structure.

Examples of the thermal polymerization initiator include azo compounds, quinines, nitro compounds, acyl halides, hydrazones, mercapto compounds, pyrylium compounds, imidazoles, chlorotriazines, benzoins, benzoin alkyl ethers, diketones, phenones, dilauroyl peroxides, and organic peroxides such as 1,1-di(t-hexylperoxy)-3,3,5-trimethylcyclohexane, available as PERHEXA TMH (NOF Corp.).

(Crosslinking Agent)

A crosslinking agent can be used for forming a crosslinked structure.

When the crosslinking agent is a high molecular weight component containing an active hydrogen group such as a hydroxyl group, it can be crosslinked by isocyanate, carbodiimide or the like.

As the crosslinking agent, an isocyanate compound is preferred, and an isocyanate compound described in the following polyurethane section can be suitably used.

It is also preferable to further add a transition metal catalyst or the like to promote the crosslinking reaction for the process of forming the adhesive sheet or the adhesive layer.

The initiator is often used at a concentration of 0.01% by mass to 10% by mass, or 0.01% by mass to 5% by mass, based on the total mass of the present adhesive agent II. A mixture of initiators may be used.

(Other Resin Components)

In the first embodiment, the present adhesive agent II may contain other resin components such as polyester, polyamide, polyolefin, and olefin-based monomers, as necessary, in addition to the above.

(Other Additives)

In the first embodiment, the present adhesive agent II may contain one or more types of other additives, such as a tackifier, a curing accelerator, a filler, a coupling agent, an ultraviolet absorber, an ultraviolet stabilizer, an antioxidant, a stabilizer, a pigment, and a rust inhibitor, as necessary, in addition to the above.

It is preferable that the amounts of these additives is typically selected so as not to adversely affect the curing of the adhesive sheet and the adhesive layer, or not to adversely affect the physical properties of the adhesive sheet and the adhesive layer.

In general, the tackifier may be an arbitrary compound or a mixture of compounds that enhances the adhesiveness of the adhesive agent composition.

The tackifier is not particularly limited, and conventionally known ones can be used. Examples thereof include terpene-based tackifiers, phenol-based tackifiers, rosin-based tackifiers, aliphatic-based petroleum resins, aromatic-based petroleum resins, copolymer-based petroleum resins, alicyclic-based petroleum resins, xylene resins, epoxy-based tackifiers, polyamide-based tackifiers, ketone-based tackifiers, and elastomer-based tackifiers; and these may be used alone or in combination of two or more types of these.

### Second Embodiment

As another preferred embodiment of the present adhesive sheet II or the present adhesive layer II (hereinafter referred to as “second embodiment”), an embodiment in which the present adhesive agent II is formed from an adhesive agent composition containing one or more of the following (d) and (e), can be cited.

(d) An acrylic polymer and a polyether-type polyurethane

(e) a mixture of monomer components constituting acrylic polymers or a partially polymerized product thereof, and a polyether-type polyurethane

As to the above (d), in the present adhesive agent II, the acrylic component segment is formed by an acrylic polymer, and the urethane component segment is formed by a polyether-type polyurethane.

As to the above (e), in the present adhesive agent II, the acrylic component segment is formed by a mixture of monomer components constituting acrylic polymers or a partially polymerized product thereof, and the urethane component segment is formed by a polyether-type polyurethane.

The adhesive agent composition containing either the above (d) or (e) may contain an initiator and/or a crosslinking agent, other resin components, and additives, as in the first embodiment, in addition to the above (d) or (e).

The adhesive agent composition is preferably a photo- or heat-curable adhesive agent composition that is cured by light or heat, and in that case, an initiator and/or a crosslinking agent is often contained therein.

The preferred embodiments of the initiator, the crosslinking agent, the other resin components, and the additives are the same as those described above, and are therefore omitted here.

(Acrylic Polymer)

In the first and second embodiments, examples of the acrylic polymer include a polymer or a copolymer containing a (meth)acrylic acid alkyl ester as a monomer.

Examples of the (meth)acrylic acid ester as a monomer having a low Tg of −45° C. to −30° C. in order to set G′(−20° C.) on the present adhesive sheet II or the present adhesive layer II to 300 kPa or less include: (meth)acrylic acid alkyl esters such as methyl (meth)acrylate, ethyl (meth)acrylate, propyl (meth)acrylate, n-butyl (meth)acrylate, tert-butyl (meth)acrylate, 2-ethylhexyl (meth)acrylate, n-hexyl (meth)acrylate, n-octyl (meth)acrylate, isooctyl (meth)acrylate, isononyl (meth)acrylate, isomyristyl (meth)acrylate, and stearyl (meth)acrylate; (meth)acrylic acid esters having a hydroxyl group such as 4-hydroxybutyl (meth)acrylate and 2-hydroxyethyl (meth)acrylate; cyclohexyl (meth)acrylate, isobornyl (meth)acrylate, benzyl (meth)acrylate, 2-butoxyethyl (meth)acrylate, 2-phenoxyethyl (meth)acrylate, glycidyl (meth)acrylate, tetrahydrofurfuryl (meth)acrylate, polypropylene glycol mono (meth)acrylate, and 2-isocyanatoethyl (meth)acrylate. These (meth)acrylic acid esters may be used alone or in combination of two or more thereof.

In addition to the (meth)acrylic acid alkyl esters, various vinyl compounds may be used as the monomer components constituting acrylic polymers.

The vinyl compounds are not particularly limited. Examples thereof include (meth)acrylamide compounds such as N,N-dimethylacrylamide, N,N-diethylacrylamide, N-isopropylacrylamide, N-hydroxyethyl acrylamide, and acrylamide; N-vinylpyrrolidone, N-vinylcaprolactam, N-vinylacetamide, N-acryloylmorpholine, acrylonitrile, styrene, and vinyl acetate. These vinyl compounds may be used alone or in combination of two or more thereof.

The hydroxyl value (mgKOH/g resin) of the acrylic polymer is preferably 5 to 200, and more preferably 20 or more or 180 or less.

The hydroxyl value of the acrylic polymer can be controlled by the polymerization composition ratio of the hydroxyl group-containing monomer component in the (meth)acrylic acid ester.

When the hydroxyl value falls within the above range, a urethane component segment utilizing the reaction with the hydroxyl group can be introduced.

The lower limit of the mass average molecular weight (Mw) of the acrylic polymer is preferably 400,000, and the upper limit thereof is preferably 1,300,000.

When the mass average molecular weight (Mw) of the acrylic polymer is 400,000 or more, the stickiness of the adhesive sheet or the adhesive layer is not too high, the punching processability can be maintained, and both the adhesive force and the restorability can be achieved.

Meanwhile, when the mass average molecular weight (Mw) of the acrylic polymer is 1,300,000 or less, it is possible to mold an adhesive sheet or an adhesive layer having a smooth surface and a small haze.

To obtain the acrylic polymer, the monomer component may be subjected to a radical reaction in the presence of an initiator.

Examples of the method for radically reacting the monomer component, that is, the polymerization method include solution polymerization (boiling-point polymerization or constant-temperature polymerization), emulsion polymerization, suspension polymerization, and bulk polymerization. Among these, solution polymerization is preferred since the molecular weight distribution (Mw/Mn) can be controlled by adjusting the initiator, the polymerization temperature, and the like.

When the solution polymerization is used as the polymerization method, examples of the reaction solvent include ethyl acetate, toluene, methyl ethyl ketone, methyl sulfoxide, ethanol, acetone, and diethyl ether. These reaction solvents may be used alone or in combination of two or more thereof.

When the solution polymerization is used as the polymerization method, the polymerization temperature is preferably about 40° C. to 90° C.

(Polyether-Type Polyurethane)

In the second embodiment, the polyether-type polyurethane is a polyurethane containing a plurality of molecular chains having a urethane bond obtained by reacting a polyether polyol with a polyfunctional isocyanate compound.

In the present invention, the polyether-type polyurethane preferably has two or more urethane bonds in the molecule.

Examples of the polyol that is usually a raw material for the polyurethane include polyether polyols, polyester polyols, polycarbonate-based polyols, polyolefin polyols, and acrylic polyols. In the present invention, it is preferable to have polyether polyols from the viewpoint of compatibility with acrylic polymers.

The polyfunctional isocyanate compound is preferably diisocyanate.

From the viewpoint of gelation prevention and compatibility with acrylic polymers, it is preferably selected from the group consisting of: 4,4′-methylenebis (phenyl isocyanate) (MDI); toluene diisocyanate (TDI); m-xylene diisocyanate (XDI); hexamethylene diisocyanate (HDI); methylenebis (4-cyclohexyldiisocyanate) (HDMI (registered trademark)); naphthalene-1,5-diisocyanate (NDI); 3,3′-dimethyl-4,4′-biphenyldiisocyanate (TODI); 1,4-di-isocyanatobenzene (PPDI); phenyl-1,4-4-diisocyanate; trimethyl hexamethyl diisocyanate (TDMI); isophorone diisocyanate (IPDI); 1,4-cyclohexyl diisocyanate (CHDI); diphenyl ether 4,4′-diisocyanate; p,p′-diphenyl diisocyanate; lysine diisocyanate (LDI); 1,3-bis(isocyanatomethyl) cyclohexane; polymethyl polyphenyl isocyanate (PMDI); and isomers and/or mixtures thereof.

As to the mass ratio of the polyether polyol that is a component derived from polyether polyol to the polyfunctional isocyanate compound that is a component derived from isocyanate, the mass ratio (% by mass) of the polyether polyol is preferably larger than that of the polyfunctional isocyanate compound, from the viewpoint of compatibility with acrylic polymers. In particular, the mass ratio (% by mass) of the polyether glycols that are components derived from polyether glycol is preferably larger than that of the polyfunctional isocyanate compound that is a component derived from isocyanate from the viewpoint of enhancing the restorability after extension, since the influence of the intermolecular hydrogen bond of the urethane component can be reduced while improving the compatibility with acrylic polymers.

Thus, the mass ratio (% by mass) of the component derived from polyether glycol is preferably larger than the mass ratio (% by mass) of the component derived from isocyanate.

In the second embodiment, the present adhesive agent II is preferably formed by curing an adhesive agent composition containing at least one of the above (d) and (e). In particular, the adhesive agent composition is preferably cured by light or heat.

By curing the adhesive agent composition, the adhesive force and the cohesive force of the present adhesive sheet II or the present adhesive layer II can be enhanced.

From the above viewpoint, the polyether-type polyurethane preferably has one or more acryloyl groups or methacryloyl groups in one molecule. By photocuring and using the adhesive agent composition having the acryloyl group or the methacryloyl group, the adhesive force and the cohesive force of the present adhesive sheet II or the present adhesive layer II can be enhanced.

In addition, in the second embodiment, by using an adhesive agent composition containing the polyether-type polyurethane having one or more acryloyl groups or methacryloyl groups in one molecule and a hydrogen abstraction-type photoinitiator, a crosslinked polymer forming a crosslinked structure between the acrylic component segment and the urethane component segment is generated, and the adhesive force and the cohesive force of the present adhesive sheet II or the present adhesive layer II can be enhanced.

Examples of the polyether-type polyurethane having one or more acryloyl groups or methacryloyl groups (hereinafter collectively referred to as (meth)acryloyl groups) in one molecule include a polyether-type polyurethane having (meth)acryloyl groups at one or both terminals.

In addition to the above, it may be a polyether-type polyurethane having a hydroxyl group and a (meth)acryloyl group in one molecule, and may be a polyether-type polyurethane having an isocyanate group and a (meth) acryloyl group in one molecule.

From the same viewpoint, the polyether-type polyurethane preferably has one or more hydroxyl groups in one molecule. When thermally curing and using the adhesive agent composition containing the polyether-type polyurethane having hydroxyl groups and a crosslinking agent such as isocyanate, a crosslinked polymer forming a crosslinked structure between the acrylic component segment and the urethane component segment is generated, and the adhesive force and the cohesive force of the present adhesive sheet II or the present adhesive layer II can be enhanced.

Examples the polyether-type polyurethane having one or more hydroxyl groups in one molecule include a polyether-type polyurethane having hydroxyl groups at one or both terminals.

<Storage Elastic Modulus>

In the present adhesive sheet II and the present adhesive layer II, the storage elastic modulus at −20° C. (G′(−20° C.)) obtained by dynamic viscoelasticity measurement in a shear mode at a frequency of 1 Hz is preferably 300 kPa or less, and more preferably 200 kPa or less.

By setting the G′ (−20° C.) in the above range, cracking of the member sheet can be prevented at bending operations when the member sheet described later is adhered to the present adhesive sheet II or the present adhesive layer II.

The adhesive sheet and the present adhesive layer II used in the bendable image display device need to be soft at the folding speed (frequency). In order to be flexible at high frequencies, G′ is required to be low in a low temperature range by temperature-time conversion measurement of dynamic viscoelasticity, that is, the glass transition temperature (Tg) of the adhesive sheet and the present adhesive layer is required to be low, and accordingly the storage elastic modulus at −20° C. (G′(−20° C.)) is required to be 300 kPa or less.

In order to achieve the above G′(−20° C.), in the present adhesive sheet II and the present adhesive layer II, the maximum value of the loss tangent (tan δ) obtained by dynamic viscoelasticity measurement in a shear mode at a frequency of 1 Hz is preferably at −20° C. or less.

In the present adhesive sheet II and the present adhesive layer II, in order to adjust the storage elastic modulus at −20° C. (G′ (−20° C.)) to the above range, an adhesive agent having a urethane component segment and an acrylic component segment may be used to adjust to the above range, and it is particularly preferable to use the adhesive agent described in the first or the second embodiment. However, it is not limited to this method.

In the present adhesive sheet II and the present adhesive layer II, the storage shear modulus at 60° C. (G′(60° C.)) obtained by dynamic viscoelasticity measurement in a shear mode at a frequency of 1 Hz is preferably 10 kPa or more, and more preferably 20 kPa or more.

When the storage shear elastic modulus (G′ (60° C.)) falls within the above range, for example, in forming a laminated sheet by adhering the present adhesive sheet II or the present adhesive layer II to a member sheet, the interlayer stress at the time of bending of the laminated sheet can be reduced at room temperature to high temperature, and delamination or cracking of the member sheet can be suppressed.

In the present adhesive sheet II and the present adhesive layer II, in order to adjust the storage elastic modulus at −20° C. (G′ (−20° C.)) to the above range, an adhesive agent having a urethane component segment and an acrylic component segment may be used to adjust to the above range, and it is particularly preferable to use the adhesive agent described in the first or the second embodiment.

<Loss Tangent (Tan δ)>

In the present adhesive sheet II and the present adhesive layer II, the maximum value of the loss tangent (tan δ) obtained by dynamic viscoelasticity measurement in a shear mode at a frequency of 1 Hz is preferably at −20° C. or lower.

The maximum value thereof is more preferably at −30° C. or lower, and even more preferably at −40° C. or lower. The lower limit thereof is not particularly limited, but is generally at −70° C. or higher.

The temperature of the maximum value is a guideline for a glass transition temperature (Tg) of the adhesive sheet. When the value is at −20° C. or lower, the storage elastic modulus at low temperatures can be sufficiently lowered to reduce the stress due to bending operations.

In the present adhesive sheet II and the present adhesive layer II, the peak of the maximum value, 0.1 or more, of the loss tangent (tan δ) in a shear at a frequency of 1 Hz is particularly preferably present in a temperature range of −60° C. to −20° C.

In the present invention, the elastic modulus (storage elastic modulus) G′, the viscosity (loss elastic modulus) G″, and the loss tangent (tan δ=G″/G′) at various temperatures can be measured by using a strain rheometer.

In the present adhesive sheet II and the present adhesive layer II, in order to adjust the maximum value of the loss tangent (tan δ) to the above range, an adhesive agent having a urethane component segment and an acrylic component segment may be used to adjust to the above range, and it is particularly preferable to use the adhesive agent described in the first or the second embodiment. However, it is not limited to these methods.

<Restoring Force>

The present adhesive sheet II or the present adhesive layer II is stretched to a length of four times the initial length by pulling both ends of the adhesive sheet or the present adhesive layer II in the opposite directions, and held in the state for 10 minutes. Then, one end is released, and the length after the elapse of 20 minutes is preferably 1.0 to 1.6 times the initial length.

The above operation is related to the restorability of the laminate in which the adhesive sheet or the present adhesive layer II is adhered to the member sheet, the present flexible image display device member II, and the image display device when they are unfolded after bending. When it falls within the above range, the folds of the laminate, the present flexible image display device member II, and the image display device are less noticeable.

In the present adhesive sheet II and the present adhesive layer II, in order to adjust the restoring force to the above range, an adhesive agent having a urethane component segment and an acrylic component segment may be used to adjust to the above range, and it is particularly preferable to use the adhesive agent described in the first or the second embodiment. However, it is not limited to these methods.

<Haze>

In the present adhesive sheet II and the present adhesive layer II, the haze is preferably less than 1.0%, and more preferably less than 0.7%.

When the present adhesive sheet II and the present adhesive layer II have a haze in the above range, they are suitably used as an adhesive sheet and an adhesive layer for image display devices.

Here, the haze is measured in accordance with JIS K7136.

When the adhesive sheet or the present adhesive layer II is a laminate adhered to a member sheet, the haze in the adhesive sheet and the present adhesive layer II can be considered to be equal or less than the value thereof by measuring the haze of the laminate.

In the present adhesive sheet II and the present adhesive layer II, in order to adjust the haze to the above range, an adhesive agent having a urethane component segment and an acrylic component segment may be used to adjust to the above range, and it is particularly preferable to use the adhesive agent described in the first or the second embodiment. However, it is not limited to these methods.

<Total Light Transmittance>

In the present adhesive sheet II and the present adhesive layer II, the total light transmittance at a thickness of 100 μm is preferably 85% or more, more preferably 88% or more, and even more preferably 91% or more.

Here, the total light transmittance is measured in accordance with JIS K7361-1.

In the present adhesive sheet II and the present adhesive layer II, in order to adjust the total light transmittance to the above range, an adhesive agent having a urethane component segment and an acrylic component segment may be used to adjust to the above range, and it is particularly preferable to use the adhesive agent described in the first or the second embodiment. However, it is not limited to these methods.

<Hansen Solubility Parameters>

In the present adhesive sheet II and the present adhesive layer II, the polar term δp is preferably 2.0 MPa^{0.5} or more, and the hydrogen bond term δh is preferably 5.0 MPa^{0.5} or more, in the Hansen solubility parameters (δd, δp, and δh) on the surface of the adhesive sheet or the adhesive layer.

When the present adhesive sheet II and the present adhesive layer II contain a urethane component segment, the δp on the surface HSPs can be increased compared to that of the adhesive sheet or the adhesive layer composed of only an acrylic component segment.

Accordingly, the wettability with various display films (member sheets) having a large δp is improved, and the interfacial adhesive force is improved, which consequently contributes to the improvement of the adhesive force in the peeling test.

Here, the Hansen solubility parameters (HSPs) are indicators representing the solubility how much a substance dissolves in another certain substance. The HSPs are represented in a three-dimensional space in which a solubility parameter introduced by Hildebrand is divided into three components of a dispersion term δd, a polar term δp, and a hydrogen bond term δh.

The dispersion term δd represents the effect of London dispersion force, the polar term δp represents the effect of dipole-dipole force, and the hydrogen bond term δh represents the effect of hydrogen bond force, and these are explained as follows (here, each unit is MPa^{0.5}.):

δd: energy derived from London dispersion force between molecules;

δp: energy derived from polar force between molecules; and

δh: energy derived from hydrogen bond force between molecules.

Definitions and calculations of the HSPs are described in the following document:

Charles M. Hansen, Hansen Solubility Parameters: A Users Handbook (CRC Press, 2007).

The dispersion term reflects the London dispersion force, the polar term reflects the dipole moment, and the hydrogen bond term reflects the action of water, alcohol, and the like. The ones whose vectors by the HSPs are similar can be determined to have high solubility, and the similarity of the vectors can be determined by the distance of the Hansen solubility parameters (HSP distance). The Hansen solubility parameters can be indicators not only for determining the solubility, but also for determining how easily a certain substance is present in another certain substance, that is, how good the dispersion is.

In the present invention, the HSPs [δ_{d}, δₚ, and δₕ] on the surface are determined by bringing 2 μL of droplets of the various solvents with known HSPs into contact with the surface of the adhesive sheet or the adhesive layer, and calculating γ_{sL} from the contact angle value after 30 seconds based on the Young-Dupre equation and the Hata-Kitazaki and extended Fowkes equation, so as to correlate Rₐ and (γ_{sL}/(V_{L}^{1/3}))^{1/2} based on the relationship between the Hansen solubility parameters and the surface tension (formula 1) (Hansen Solubility Parameters 50th Anniversary Conference, preprint 2017 PP. 14-21 (2017)).

δd²+δP²+0.068δh²=13.9γ_{sL}(1/(V_{L}^{1/3})) (formula 1)

In the present adhesive sheet II and the present adhesive layer II, the polar term δp is preferably 2.0 MPa^{0.5} or more, and more preferably 3.0 MPa^{0.5} or more, in the Hansen solubility parameters (δd, δp, and δh) on the surface of the adhesive sheet or the adhesive layer.

In addition, the hydrogen bond term δh is preferably 5.0 MPa^{0.5} or more, and more preferably 6.0 MPa^{0.5} or more.

When the δp and δh of the present adhesive sheet II and the present adhesive layer II fall within the above range, the wettability to highly polar (optical) member sheets such as polyamide, polyimide, epoxy, polyester, and TAC films is improved, and the interfacial adhesive force is enhanced, so that the adhesive force can be improved compared to that of conventional acrylic adhesive sheets.

As described above, since the present adhesive sheet II and the present adhesive layer II contain the urethane component segment that is a component having high δp and δh, the δp and δh on the surface HSPs can be increased compared to that of the adhesive sheet composed of only the acrylic component segment.

In addition, in order to further increase the δp and δh on the surface HSPs, it is preferable to adjust the blending amount so as to expose the urethane component segment to the adhesive sheet surface, or to form the present adhesive sheet II and the present adhesive layer II using the adhesive agent described in the first or second embodiment.

<Gel Fraction>

The gel fraction of the present adhesive sheet II and the present adhesive layer II is preferably 55% or more, more preferably 60% or more, and even more preferably 65% or more.

When the gel fraction of the present adhesive sheet II and the present adhesive layer II is 55% or more, the shape can be sufficiently maintained.

In the present adhesive sheet II and the present adhesive layer II, in order to adjust the gel fraction to the above range, the degree of crosslinking may be adjusted in the producing process of the present adhesive sheet II and the present adhesive layer II, for example, when the adhesive resin composition is cured by light or heat as described below. For example, in the case of photocrosslinking a polyether-type polyurethane and an acrylic polymer, the degree of crosslinking can be adjusted by adjusting the irradiation amount of light or the like, and accordingly the gel fraction can be adjusted. However, it is not limited to this method.

<Thickness>

The thickness of the present adhesive sheet II and the present adhesive layer II is not particularly limited. It is preferably 0.005 mm or more, more preferably 0.010 mm or more, and even more preferably 0.150 mm or more.

Meanwhile, the upper limit is preferably 1.000 mm or less, more preferably 0.700 mm or less, and even more preferably 0.500 mm or less.

When the thickness is 0.005 mm or more, the handleability is good, and when the thickness is 1.000 mm or less, it is possible to contribute to thinning of a laminate adhered with a member sheet.

<Preferred Applications of Present Adhesive Sheet II>

The present adhesive sheet II is preferably used for adhering a member constituting a display member (also referred to as “display member”), especially for adhering a flexible member for displays used for producing displays, and is particularly preferred for use as an adhesive component for flexible displays used for producing flexible displays.

As to the flexible member, the same flexible member as described later can be used.

<Constituent Element of Present Flexible Image Display Device Member II>

Next, elements other than the present adhesive layer II among the constituent elements of the present flexible image display device member II will be described.

<Flexible Member>

Examples of the flexible member constituting the present flexible image display device member II include flexible displays such as an organic electroluminescence (EL) display; and flexible members for displays such as a cover lens (cover film), a polarizing plate, a polarizer, a retardation film, a barrier film, a viewing angle compensation film, a luminance-improving film, a contrast-improving film, a diffusion film, a semi-transmissive reflective film, an electrode film, a transparent conductive film, a metal mesh film, and a touch sensor film. Any one or two types of these may be used in combination. For example, a combination of a flexible display and one other type of flexible member, or a combination of a cover lens and one other type of flexible member can be cited.

Here, the flexible member means a member capable of being bent, and particularly a member capable of being bent repeatedly. In particular, it is preferably a member capable of being fixed in a curved shape having a bending radius of 25 mm or more, especially a member capable of withstanding repeated bending actions at a bending radius of less than 25 mm, and more preferably less than 3 mm.

<HSPs of Flexible Member>

For the reasons described below, in the HSPs on the surface of at least one of the above two flexible members, the δp is preferably 10.0 MPa^{0.5} or more and 20.0 MPa^{0.5} or less. Although polyamide, polyimide, polyester, epoxy resins, and the like are usually in this range, the interfacial adhesive force to the adhesive layer can be enhanced by adjusting the δp to the above range through corona treatment, plasma treatment, primer treatment, or the like.

<HSP Distance (Ra)>

Also, for the same reasons as described below, in the present flexible image display device member II, the HSP distance (Ra) between the Hansen solubility parameters on the flexible member surface and the Hansen solubility parameters on the present adhesive layer II surface is preferably 17.0 or less, more preferably 16.0 or less, and even more preferably 15.0 or less.

The method for calculating the HSP distance (Ra) is also described below.

For the reasons described below, for example, the 180 degree peel strength of the adhesive layer at a peel speed of 300 mm/min at 60° C. (JIS Z 0237) can be 8 N/25 mm or more, and more preferably 10 N/25 mm or more, with respect to a flexible member, especially to a flexible member composed of a highly polar film.

When the adhesive force between the flexible member and the present adhesive layer II falls within the above range, the reliability of the image display device can be improved without peeling off the flexible member due to stress during bending.

Here, the flexible member means a member capable of being bent, and particularly a member capable of being bent repeatedly. In particular, it refers to a member capable of being fixed in a curved shape having a bending radius of 25 mm or more, especially a member capable of withstanding repeated bending actions at a bending radius of less than 25 mm, and more preferably less than 3 mm.

<<Present Component II>>

The adhesive component according to an example of the embodiments of the present invention (hereinafter referred to as “present component II”) contains the above-mentioned adhesive agent (the present adhesive agent II as described above) having a urethane component segment and an acrylic component segment, and can be suitably used for flexible devices such as wearable electronic equipment and folderable displays.

The present component II preferably has one or more of the above-mentioned predetermined properties (such as storage elastic modulus, loss tangent (Tan δ), restoring force, haze, total light transmittance, Hansen solubility parameters, and gel fraction).

Among them, it is preferable that in the Hansen solubility parameters (δd, δp, and δh) on the surface of the present component II, the polar term δp is 2.0 MPa^{0.5} or more and the hydrogen bond term δh is 5.0 MPa^{0.5} or more.

With the appearance of bendable image display devices, member sheets used for them that are capable of bending are also being used. For example, transparent polyimide films that are resistant to tensile stress due to bending, are hard to whiten, have high high-temperature reliability, and have excellent scratch resistance have been employed as front cover films.

Such transparent polyimide films contain a large amount of an aromatic skeleton and an imide group and/or an amide group in order to achieve both high-temperature reliability and transparency, and may contain a fluorine-based functional group depending on the type.

Thus, the films are extremely high in polarity, and the adhesive components that have been used for conventional displays are unable to adhere firmly when applied to flexible devices, resulting in a problem that the films may be peeled off due to the stress of bending or the display user may mistake the films for a part of protective films and remove them.

In addition, polarizing plate assemblies are becoming thinner and thinner. Although thin member sheets having a high polarity on the outermost surface obtained by laminating a coating-type liquid crystal layer or a TAC film (cellulose triacetate film) on the outermost surface have been introduced, such member sheets have been difficult to be firmly adhered by conventional adhesive components.

For these problems, by setting the Hansen solubility parameters (δp and δh) on the surface of the present component II to the above range, the wettability to highly polar (optical) member sheets such as polyamide, polyimide, epoxy, polyester, and TAC films is improved, and the interfacial adhesive force is enhanced, so that the adhesive force can be improved compared to that of conventional acrylic adhesive components.

<<Present Laminate II>>

The laminate according to an example of the embodiments of the present invention (hereinafter may be referred to as “present laminate II”) is a laminate having a member sheet on at least one surface of the present adhesive sheet II or the present adhesive layer II described above.

The present laminate II may be a laminated sheet having a configuration in which a member sheet (hereinafter may be referred to as “first member sheet”), the present adhesive sheet II or the present adhesive layer II, and optionally a member sheet (hereinafter may be referred to as “second member sheet”) are laminated in this order. In this case, the first member sheet and the second member sheet may be the same or may be different.

<Member Sheet>

Examples of the main component of the member sheet to be the adherend of the present adhesive sheet II or the present adhesive layer II include polycycloolefin, triacetyl cellulose, polymethyl methacrylate, polyester, epoxy resin, polyimide, and polyamide; and one or two or more types of these resins may be used.

Here, the term “main component” refers to a component occupying the largest mass ratio. Specifically, it occupies 50% by mass or more, preferably 55% by mass or more, and more preferably 60% by mass or more (including 100% by mass) in the member sheet or the composition forming the member sheet.

The member sheet may be an ultra-thin film glass (UTG). Here, the ultra-thin film glass refers to a chemically strengthened glass having a thickness of 70 μm or less.

Among them, a member sheet containing one or two or more resins selected from the group consisting of polyamide, polyimide, epoxy resin, triacetyl cellulose, and polyester as the main component has particularly high polar, but the effect can be particularly found since the present adhesive sheet II has high δp and δh.

Among them, a polyimide film containing polyimide as the main component is suitably used as a member sheet for flexible displays since it has a high Tg, a low linear expansion coefficient, excellent high-temperature reliability, high tensile strength, and is unlikely to cause whitening due to bending. Ordinary polyimide is often brown in color, but a transparent polyimide film in which the chemical structures of the diamine component and the dicarboxylic acid component are appropriately selected and the band gap is adjusted, is particularly preferable.

<Thickness>

The thickness of the present laminate II is not particularly limited. As an example of the case where the present laminate II is used in an image display device, the present laminate II may have a sheet shape. When the thickness is 0.01 mm or more, the handleability is good, and when the thickness is 1.0 mm or less, it is possible to contribute to thinning of laminates.

Accordingly, the thickness of the present laminate II is preferably 0.01 mm or more, more preferably 0.03 mm or more, and particularly preferably 0.05 mm or more. Meanwhile, the upper limit is preferably 1.0 mm or less, more preferably 0.7 mm or less, and particularly preferably 0.5 mm or less.

<HSPs of Member Sheet>

In the present laminate II, in the HSPs on the member sheet surface, the δp is preferably 10.0 MPa^{0.5} or more and 20.0 MPa^{0.5} or less. Although polyamide, polyimide, polyester, epoxy resins, and the like are usually in this range, the interfacial adhesive force to the adhesive sheet can be enhanced by adjusting the δp to the above range through corona treatment, plasma treatment, primer treatment, or the like.

<HSP Distance (Ra)>

The adhesive force between the member sheet and the adhesive sheet or the present adhesive layer II is usually determined by the viscoelastic element such as the magnitude of the loss elastic modulus (G″) at a peeling frequency (speed), and the interfacial adhesive force element such as wetting.

However, the adhesive sheet or the adhesive layer having a low Tg for bending may not be expected to be significantly improved due to restrictions on viscoelasticity, and it has been found rather that controlling the HSPs on the surface of the adhesive sheet or the adhesive layer and improving the interfacial adhesive force can effectively increase the adhesive force.

Therefore, in the present laminate II, the HSP distance (Ra) between the Hansen solubility parameters on the member sheet surface and the Hansen solubility parameters on the surface of the present adhesive sheet II or the present adhesive layer II is preferably 17 or less, more preferably 16 or less, and even more preferably 15 or less.

Here, the HSP distance (Ra) is calculated by the following formula 2.

HSP distance (Ra)={4×(δd_{A}−δd_{S})²+(δp_{A}−δp_{S})²+(δh_{A}−δh_{S})²}^{0.5} (formula 2)

In the formula 2, δd_{A}, δp_{A}, and δh_{A} represent δd, δp, and δh of the present adhesive sheet II, respectively; and δd_{S}, δp_{S}, and δh_{S} represent δd, δp, and δh of the present member sheet, respectively.

When the HSP distance (Ra) falls within the above range, the adhesive force between the member sheet and the present adhesive sheet II or the present adhesive layer II can be sufficiently enhanced.

There are various methods for evaluating the adhesive force. For example, in the present adhesive sheet II, the 180 degree peel strength at a peel speed of 300 mm/min at 60° C. (JIS Z 0237) can be 8 N/25 mm or more, and more preferably 10 N/25 mm or more, with respect to a member sheet, especially to a member sheet composed of a highly polar film.

When the adhesive force between the member sheet and the present adhesive sheet II or the present adhesive layer II falls within the above range, the reliability of the image display device can be improved without peeling off the member sheet due to stress during bending.

In order to set the HSP distance in the above range, for example, the urethane component of the present adhesive sheet II or the present adhesive layer II may be increased to enhance the δp and δh, or a primer having HSPs close to the HSPs on the present adhesive sheet II or the present adhesive layer II may be coated on the member sheet side. However, it is not limited to these methods.

<Haze of Laminate>

The haze in the present laminate II is preferably less than 1.0%, and more preferably less than 0.7%.

When the haze in the present laminate II falls within the above range, the present laminate II can be suitably used as a constituent member for image display devices.

Here, the haze is measured in accordance with JIS K7136.

<<Method for Producing Present Adhesive Sheet II and Present Adhesive Layer II>>

As an example of the method for producing the present adhesive sheet II, a method in which an adhesive agent composition containing a “polyether-type polyurethane forming a urethane component segment in the present adhesive sheet II” and an “acrylic polymer forming an acrylic component segment in the present adhesive sheet II” is molded into a sheet shape, cured by light or heat, and if necessary, processed appropriately to produce the present adhesive sheet II, can be cited. However, it is not limited to this method.

As another example of the method for producing the present adhesive sheet II, a method in which a composition containing a graft polymer having a stem polymer composed of an acrylic polymer, and a branch polymer composed of a polyether-type polyurethane (also referred to as “graft chain”) as the main component resin is molded into a sheet shape, cured by light or heat, and if necessary, processed appropriately to produce the present adhesive sheet II, can be cited. However, it is not limited to this method.

As an example of the method for producing the adhesive layer II, after preparing the adhesive agent composition in the same manner as described above, this is coated on a member sheet or a flexible member, and the resin composition is cured by light or heat to form the present adhesive layer II. However, it is not limited to this method.

It is considered that by further reacting the adhesive agent composition with light or heat, a structure in which the acrylic component segment and the urethane component segment are bonded can be consequently obtained, and thus the present adhesive sheet II having the viscoelasticity of the adhesive sheet or the present adhesive layer II adjusted to the above range can be obtained.

However, these production methods are examples of the method for producing the present adhesive sheet II and the present adhesive layer II, and the present adhesive sheet II and the present adhesive layer II are not limited to those produced by these production methods.

<Mixing and Kneading of Raw Materials>

In preparing the adhesive agent composition, the above raw materials may be kneaded using a temperature-controllable kneader (for example, a disperser, a single-screw extruder, a twin-screw extruder, a planetary mixer, a twin-screw mixer, and a pressure kneader).

In mixing various raw materials, various additives such as a silane coupling agent and an antioxidant may be blended with the resin in advance, and then supplied to the kneader; or all the materials are melt-mixed in advance, and then supplied thereto; or a master batch in which only the additives are concentrated in the resin in advance may be prepared, and supplied thereto.

<Molding>

Examples of the method for molding the adhesive agent resin composition into a sheet shape include known methods, such as a wet laminating method, a dry laminating method, an extrusion casting method using a T-die, an extrusion laminating method, a calender method, an inflation method, an injection molding method, and a liquid injection curing method. Among them, a wet laminating method, an extrusion casting method, and an extrusion laminating method are preferred for producing sheets.

<Curing>

To cure the present adhesive sheet II and the present adhesive layer II, the adhesive agent composition may be coated on a member sheet such as a mold release sheet and polymerized, or the adhesive agent composition may be polymerized and cured, and then adhered to a member sheet or the like.

When the adhesive agent composition contains an initiator, a cured product can be produced by irradiating with heat and/or active energy rays for curing. In particular, the present adhesive sheet II and the present adhesive layer II can be produced by irradiating a molded body of the adhesive agent composition with heat and/or active energy rays.

Examples of the active energy rays to be irradiated include ionizing radiation such as α-rays, β-rays, γ-rays, neutron rays, and electron beams; ultraviolet rays; and visible rays. Among them, ultraviolet rays are preferred from the viewpoint of suppressing damage to optical device constituent members and of the reaction control.

The irradiation energy, irradiation time, and irradiation method of the active energy rays are not particularly limited.

<Another Method>

As another embodiment of the method for producing the present adhesive sheet II and the present adhesive layer II, the above-mentioned adhesive agent composition may be dissolved in an appropriate solvent, and various coating methods may be applied.

In the case of using the coating method, the present adhesive sheet II can also be obtained by heat-curing in addition to the above-mentioned active energy ray irradiation curing.

In the case of using the coating method, the thickness of the adhesive sheet can be adjusted by the coating thickness and the solid content concentration of the coating liquid.

<Surface Treatment>

From the viewpoint of preventing blocking and foreign material adhesion, it is preferable to laminate a protective film on at least one surface of the present adhesive sheet II or the present adhesive layer II.

Alternatively, embossing or various unevenness (cone, pyramid shape, hemispherical shape, or the like) may be processed on at least one surface of the present adhesive sheet II or the present adhesive layer II, as necessary.

In addition, for the purpose of improving adhesion to various adherend members, various surface treatments such as corona treatment, plasma treatment, and primer treatment may be performed on the surface of the present adhesive sheet II.

In particular, the present adhesive sheet II or the present adhesive layer II may be a laminate having a mold release film laminated on at least one surface thereof.

Here, as the mold release film, it is preferable to use a mold release-treated polyethylene terephthalate (PET) film from the viewpoint of light transmittance and cost.

<Method for Producing Present Flexible Image Display Device Member II>

The method for producing the present flexible image display device member II is not particularly limited. As described above, it may be formed by coating the resin composition for forming the present adhesive layer II on a flexible member, or by forming the resin composition into a sheet shape in advance and then adhering to a flexible member.

<<Present Image Display Device II>>

By incorporating the present laminate II, for example, by laminating the present laminate II on another image display device constituent member, an image display device provided with the present laminate II (also referred to as “present image display device II”) can be formed.

In particular, the present laminate II prevents delamination and cracking of the laminated sheet even when it is folded under low and high temperature environments, and has good restorability, thereby capable of forming a flexible image display device.

Here, the flexible image display device refers, more specifically, to an image display device composed of a member capable of being fixed in a curved shape having a bending radius of 25 mm or more, and particularly to a member capable of withstanding repeated bending actions at a bending radius of less than 25 mm, and more preferably less than 3 mm.

Examples of the other image display device constituent members include optical films such as a cover lens protective film, a cover lens, a polarizing film, and a retardation film as described above, and flexible members such as a liquid crystal material and a backlight panel.

<<Explanation of Terms and Phrases>>

In the present invention, the term “film” is intended to include “sheet”, and the term “sheet” is intended to include “film”.

In addition, when the term “panel” is used, such as in an image display panel and a protective panel, it is intended include a plate body, a sheet, and a film.

In the case of being described as the phrase “X to Y” (X and Y represent arbitrary numbers) in the present specification, the phrase includes the meaning of “preferably more than X” or “preferably less than Y” along with the meaning “X or more and Y or less”, unless otherwise stated.

Also, the phrase “X or more” (C represents an arbitrary number) or “Y or less” (Y represents an arbitrary number) includes the meaning “preferably more than X” or “preferably less than Y”, unless otherwise stated.

### EXAMPLES

The present invention will be further described with reference to Examples below. However, Examples are not intended to limit the present invention by any method.

### First Example Group

First, Examples related to the flexible image display device member I proposed by the present invention will be described.

1. Raw Materials

(1) Urethane polymer: mass average molecular weight of 600,000, polyether-type OH group-terminated urethane prepolymer (19 wt. % of hexamethylene diisocyanate, 5 wt. % of isophorone diisocyanate, and 76 wt. % of polypropylene glycol)

(2) Urethane graft acrylic polymer: mass average molecular weight of 700,000 (polymer containing a copolymer composed of butyl acrylate and 2-hydroxyethyl acrylate as a stem polymer, and a urethane polymer having a molecular weight of 8,600 as a graft chain in an amount of 1.2 wt. %)

(3) Bifunctional urethane acrylate: SHIKOH UV-3700B (Mitsubishi Chemical Corporation)

(4) Acrylic polymer (a): mass average molecular weight of 600,000, polymer composed of 54 wt. % of 2-ethylhexyl acrylate, 7 wt. % of 4-hydroxybutyl acrylate, 2 wt. % of N-vinylpyrrolidone, and 37 wt. % of lauryl acrylate

(5) Acrylic polymer (b): mass average molecular weight of 680,000, polymer composed of 80 wt. % of n-hexyl acrylate and 20 wt. % of 4-hydroxybutyl acrylate

(6) Esacure TZT (photopolymerization initiator, mixture of 2,4,6-trimethylbenzophenone and 4-methylbenzophenone, manufactured by IGM)

(7) Coronate L: isocyanate-based crosslinking agent, manufactured by Tosoh Corporation

(8) NACEM aluminum: acetylacetone metal complex, manufactured by Nippon Kagaku Sangyo Co., Ltd.

(9) Solvent: ethyl acetate

<Method for Producing Adhesive Sheet>

The raw materials were uniformly mixed according to the formulations shown in Table 1, and ethyl acetate was added so as to have a solid content of 30 wt. % to prepare a liquid. Next, the prepared liquid was spread on a mold release-treated polyethylene terephthalate film (Diafoil MRV (V03) having a thickness of 100 μm, manufactured by Mitsubishi Chemical Corporation) using a bird film applicator manufactured by Elcometer Ltd., and dried in an oven at 90° C. for 10 minutes.

For Examples I-1 to I-2 and Comparative Examples I-1 to I-3, the resulting product was thermally crosslinked by heat treatment at 120° C. for 3 minutes, and a mold release-treated polyethylene terephthalate film (Diafoil MRQ having a thickness of 50 μm, manufactured by Mitsubishi Chemical Corporation) was laminated thereon by a hand roll and aged at 50° C. for 24 hours to obtain an adhesive sheet sandwiched between the mold release films.

For Example I-3, after drying, the resulting product was crosslinked by irradiating with UV of 1.5 J/cm² using a high-pressure mercury lamp in a state where both surfaces were laminated with the mold release PET films.

The thickness of each adhesive sheet was set as shown in Table 1 by adjusting the gap of the applicator.

<Evaluation Tests of Adhesive Sheet>

(Gel Fraction)

The adhesive sheet prepared in each of Examples and Comparative Examples, from which the mold release films were removed, was measured as follows:

1) the adhesive sheet was weighed (W1), and wrapped in a pre-weighed 200-mesh SUS (made of stainless steel) mesh (W0);

2) the SUS mesh was immersed in 100 mL of ethyl acetate for 24 hours;

3) the SUS mesh was taken out, and dried at 75° C. for 4.5 hours; and

4) the mass after drying (W2) was measured, and the gel fraction of the adhesive sheet was determined by the following formula.

Gel fraction (%)=100×(W2−W0)/W1

(Surface HSPs and HSP Distance (Ra))

The HSPs on the surface of the adhesive sheet was measured as follows.

The mold release PET film was peeled off from one surface of the adhesive sheet prepared in each of Examples and Comparative Examples to expose the adhesive sheet, and 2 μL of droplets of 11 types of HSPs-known solvents were dropped thereon to record the contact angle after 30 seconds. From the contact angle value, γ_{sL} was calculated based on the Young-Dupre equation and the Hata-Kitazaki and extended Fowkes equation, and the HSPs were determined so as to correlate Rₐ and (γ_{sL}/(V_{L}^{1/3}))^{1/2} based on the relationship between the Hansen solubility parameters and the surface tension (formula 1) (Hansen Solubility Parameters 50th Anniversary Conference, preprint 2017 PP. 14-21 (2017)).

δ_{d}²+δₚ²+0.068δₕ²=13.9γ_{sL}(1/(V_{L}^{1/3})) (formula 1)

As for the surface of the member sheet, the HSPs were determined by the same procedure. The results are shown in Table 1.

Further, the HSP distance (Ra) was calculated from the values of the HSPs on the adhesive sheet surface and the HSPs on the member sheet surface as measured above.

(Dynamic Viscoelasticity)

The mold release films on both surfaces were peeled off from the adhesive sheet prepared in each of Examples and Comparative Examples, and a plurality of the adhesive sheets was laminated to prepare a sheet having a thickness of approximately 0.8 mm. Then, the sheet was punched into a circle having a diameter of 8 mm and subjected to a measurement using a rheometer (DHR-2, manufactured by TA Instruments Japan Inc.) under the conditions where the adhesive jig was 08 mm parallel plate, the strain was 0.1%, the frequency was 1 Hz, the temperature was −70° C. to 100° C., and the temperature rise rate was 3° C./min, thereby obtaining a storage elastic modulus (G′), loss elastic modulus (G″), and loss tangent (tan δ) of the adhesive sheet.

The results are shown in Table 1.

(Adhesive Force)

A CPI film (50 μm) manufactured by Kolon Corporation serving as a member sheet was adhered to a SUS plate with a double-sided tape, and the mold release PET film was peeled off from one surface of the adhesive sheet prepared in each of Examples and Comparative Examples to expose the adhesive sheet. Then, a polyethylene terephthalate film (“Diafoil S-100” having a thickness of 50 μm, manufactured by Mitsubishi Chemical Corporation) serving as a backing film was roll-pressed to the adhesive sheet using a hand roller. This was cut into a strip shape with a width of 25 mm and a length of 150 mm, and a CPI film (50 μm) manufactured by Kolon Corporation serving as a member sheet was roll-adhered to the adhesive surface exposed by peeling the remaining mold release film, by using a hand roller. The member sheet surface was adhered to a SUS plate with a double-sided tape to prepare a laminate composed of the SUS plate/double-sided tape/member sheet (CPI)/adhesive sheet/and backing film (PET). Then, the laminate was subjected to an autoclave treatment (a gauge pressure of 0.2 MPa at 60° C. for 20 minutes) for finish-adhesion to prepare a sample for measuring the adhesion force between the adhesive sheet and the member sheet.

The backing film was peeled off from the member sheet while pulling the backing film at an angle of 180° at a peel speed of 300 mm/min at 60° C. to measure the tensile strength using a load cell, and the 180-degree peel strength (N/25 mm) of the adhesive sheet with respect to the member sheet at an adhesive force of 0.3 m/min was measured. The results are shown in Table 1.

<Preparation of Laminate>

The mold release film on one surface of the adhesive sheet prepared in each of Examples and Comparative Examples was peeled off, and a CPI film (50 μm) manufactured by Kolon Corporation was roll-adhered thereon. Then, the remaining mold release film was peeled off, and another CPI film (50 μm) manufactured by Kolon Corporation was adhered thereon to obtain a laminate. Then, the laminate was subjected to an autoclave treatment (a gauge pressure of 0.2 MPa at 60° C. for 20 minutes) for finish-adhesion to obtain a laminate as an evaluation sample.

(Folding Storage Properties)

The laminate thus obtained was cut into a size of 40 mm×100 mm to obtain an evaluation sample for folding storage properties. The evaluation sample was folded and fixed in a U-shape with a radius of curvature R of 3 mm, and stored in an environment of 85° C. and 85% RH for 24 hours.

The evaluation sample was visually observed after the test. Those in which peeling or foaming was observed at the interface between the member sheet and the adhesive sheet were evaluated as “x (no good)”, and those in which the above defects were not observed were evaluated as “◯ (good)”. Those with good restorability, in which no particular defect was observed and the restoration angle of the laminate was restored to 1500 or more, were determined as “⊚ (very good)”. The results are shown in Table 1.

(Haze)

The laminate prepared by adhering the member sheet on both surfaces of the adhesive sheet was used as an evaluation sample. The haze value was measured in accordance with JIS K7136 using a haze meter (“NDH5000”, manufactured by Nippon Denshoku Industries Co. Ltd.). The results are shown in Table 1.

The results of the adhesive sheet formulation, the gel fraction of the adhesive sheet, the dynamic viscoelasticity of the adhesive sheet, the HSPs on the adhesive sheet surface, the HSP distance between the adhesive sheet and the member sheet, the adhesive force, and the test of the folding storage properties are shown in Table 1.

TABLE 1

| | | | | | | Comparative | Comparative | Comparative |
|---|---|---|---|---|---|---|---|---|
| | | | Exam- | Exam- | Exam- | Exam- | Exam- | Exam- |
| | | | ple I-1 | ple I-2 | ple I-3 | ple I-1 | ple I-2 | ple I-3 |
| Adhe- | Formulations | Urethane polymer | 99.7 | 99.7 | | | | |
| sive | (solid content) | Urethane graft acrylic polymer | | | 94 | | | |
| sheet | (parts by weight) | SHIKOH UV-3700B | | | 3 | | | |
| | | (Bifunctional urethane acrylate) | | | | | | |
| | | Acrylic polymer (a) | | | | 99.5 | 99.5 | |
| | | Acrylic polymer (b) | | | | | | 99.5 |
| | | Esacure TZT | | | 3 | | | |
| | | Coronate L | 0.3 | 0.3 | | 0.5 | 0.5 | 0.5 |
| | | NACEM aluminum | 0.01 | 0.01 | | 0.01 | 0.01 | 0.01 |
| | Curing conditions | | 12° C., | | UV | 120° C., | | |
| | | | 3 min | | 1.5 J/cm² | 3 min | | |
| | Gel fraction (%) | | 79 | 81 | 69 | 66 | 68 | 74 |
| | G′ (kPa) | −20° C. | 805 | 806 | 243 | 90 | 90 | 142 |
| | | 25° C. | 236 | 240 | 46 | 21 | 21 | 50 |
| | | 85° C. | 100 | 101 | 20 | 8 | 9 | 23 |
| | Tg (° C.) | tanδ maximum value | −45 | −45 | −37 | −46 | −46 | −45 |
| | | temperature | | | | | | |
| | HSPs | δd | 19.8 | 19.8 | 18.7 | 20.5 | 20.5 | 20 |
| | (MPa^{0.5}) | δp | 5.4 | 5.4 | 6.9 | 0 | 0 | 1.5 |
| | | δh | 8.7 | 8.7 | 5.5 | 0 | 0 | 4.0 |
| | | δ total | 22.3 | 22.3 | 20.6 | 20.5 | 20.5 | 20.5 |
| | Thickness (μm) | | 50 | 25 | 50 | 50 | 25 | 50 |
| Lami- | Member sheet | Types | KOLON CPI 50 μm | | | | | |
| nate | | Member sheet HSP δd (MPa^{0.5}) | 19.4 | | | | | |
| | | Member sheet HSP δp (MPa^{0.5}) | 18.6 | | | | | |
| | | Member sheet HSP δh (MPa^{0.5}) | 8.9 | | | | | |
| | | Member sheet HSP δ total | 28.3 | | | | | |
| | | (MPa^{0.5}) | | | | | | |
| | HSP distance (Ra) | | 13.2 | 13.2 | 12.6 | 20.7 | 20.7 | 17.8 |
| | Haze (%) | | 0.6 | 0.5 | 0.6 | 0.6 | 0.5 | 0.6 |
| | 0.3 m/min adhesive | 23° C. | 38.8 | 34.5 | 35.4 | 18.3 | 15.7 | 17.5 |
| | force (N/25 mm) | 60° C. | 15.1 | 13.4 | 11.2 | 9.1 | 8.1 | 9.8 |
| | Folding storage | R = 3, 24 h, 85° C., 85% RH | ◯ | ◯ | ⊚ | X | X | X |

From the results in Examples I-1 to I-3, it was found that by adjusting the formulation of the adhesive sheet so as to increase the δp and δh, the HSP distance to the highly polar member sheet became closer, and the adhesive force was improved accordingly.

In general, thin adhesive sheets tended to have defects in folding storage, but in Example I-2, it was shown that even the thin adhesive sheet suppressed delamination and foaming of the laminate.

The adhesive sheet in Example I-3 using the acrylic polymer grafted with urethane was particularly excellent in bending resistance.

On the other hand, in Comparative Examples I-1 to I-3 composed of the acrylic polymer, the δp and δh were small, the adhesive force to the highly polar member sheet was inferior, and the peeling occurred in the test of the folding storage properties.

### Second Example Group

Next, Examples related to the flexible image display device member II proposed by the present invention will be described.

<Raw Materials>

(A-1) Acrylic polymer (trade name: ACRIT 6HY-3030, by Taisei Fine Chemical Co., Ltd., copolymer composed of butyl acrylate and 2-hydroxyethyl acrylate, mass average molecular weight: approximately 600,000, hydroxyl value: 24 [KOH·mg/g])

(A & B) Acrylic polymer-grafted polyurethane (acrylic polymer containing a copolymer composed of butyl acrylate and 2-hydroxyethyl acrylate as a stem polymer, and 1.2 wt. % of polyurethane (one-terminal acryloyl group) having a molecular weight of 8,600 as a graft chain, mass average molecular weight: approximately 700,000)

(B-1) Acryloyl group-terminated polyurethane (polyurethane composed of hexamethylene diisocyanate (HDI) and polypropylene glycol (PPG), in which hydroxyethyl acrylate (HEA) was added to both terminals, mass average molecular weight: approximately 8,000, mass ratio of PPG (polyurethane: 100 wt. %): approximately 69 wt. %)

(B-2) OH group-terminated polyurethane (19 wt. % of hexamethylene diisocyanate (HDI), 5 wt. % of isophorone diisocyanate, 76 wt. % of polypropylene glycol (PPG), mass average molecular weight: approximately 600,000)

(C) Other resins: urethane acrylate (trade name: SHIKOH UV-3700B, by Mitsubishi Chemical Corporation, bifunctional urethane acrylate)

(D) Photopolymerization initiator: Esacure TZT (photopolymerization manufactured by IGM, a mixture of 2,4,6-trimethylbenzophenone and 4-methylbenzophenone)

(E) Crosslinking agent: Coronate L (isocyanate-based crosslinking agent, manufactured by Tosoh Corporation)

(F) Catalyst: NACEM aluminum (acetylacetone metal complex, manufactured by Nippon Kagaku Sangyo Co., Ltd.)

<Method for Producing Adhesive Sheet>

The raw materials were uniformly mixed so as to have the formulations (solid content) shown in Table 2, and ethyl acetate was added so as to have a solid content of 30 wt. % to prepare a coating liquid.

Next, the liquid was spread on a mold release-treated polyethylene terephthalate film (Diafoil MRV (V03) having a thickness of 100 μm, manufactured by Mitsubishi Chemical Corporation) using a bird film applicator manufactured by Elcometer Ltd., and dried in an oven at 90° C. for 10 minutes.

For Example II-5 and Comparative Example II-1, the resulting product was further thermally crosslinked by heat treatment at 120° C. for 3 minutes, and a mold release-treated polyethylene terephthalate film (Diafoil MRQ having a thickness of 50 μm, manufactured by Mitsubishi Chemical Corporation) was laminated thereon by a hand roll and aged at 50° C. for 24 hours to obtain an adhesive sheet sandwiched between the mold release films.

For Examples II-1 to II-4 and Comparative Example II-2, each of which contained a photopolymerization initiator, after drying, a mold release-treated polyethylene terephthalate film (Diafoil MRQ having a thickness of 50 μm, manufactured by Mitsubishi Chemical Corporation) was laminated on the resulting product by a hand roll, and cured by irradiating with UV of 0.7 J/cm² using a high-pressure mercury lamp in a state where both surfaces were laminated with the mold release PET films.

The thickness of each adhesive sheet was set as shown in Table 2 by adjusting the gap of the applicator.

<Evaluation Tests of Adhesive Sheet>

(Gel Fraction)

The adhesive sheet prepared in each of Examples and Comparative Examples, from which the mold release films were removed, was measured as follows:

1) approximately 150 mg of the adhesive sheet was weighed (W1), and wrapped in a pre-weighed 200-mesh SUS (made of stainless steel) mesh (W0);

2) the SUS mesh was immersed in 100 mL of ethyl acetate for 24 hours;

3) the SUS mesh was taken out, and dried at 75° C. for 4.5 hours; and

4) the mass after drying (W2) was determined, and the gel fraction of the adhesive sheet was measured by the following formula.

Gel fraction (%)=100×(W2−W0)/W1

(Surface HSPs and HSP Distance (Ra))

The HSPs on the surface of the adhesive sheet was measured as follows.

The mold release PET film was peeled off from one surface of the adhesive sheet to expose the adhesive sheet, and 2.0 μL of droplets of 11 types of HSPs-known solvents were dropped thereon to record the contact angle after 30 seconds. From the contact angle value, γ_{sL} was calculated based on the Young-Dupre equation and the Hata-Kitazaki and extended Fowkes equation, and the HSPs were determined such that Rₐ and (γ_{sL}/(V_{L}^{1/3}))^{1/2} were most correlated based on the relationship between the Hansen solubility parameters and the surface tension (formula 1) (Hansen Solubility Parameters 50th Anniversary Conference, preprint 2017 PP. 14-21 (2017)).

δ_{d}²+δₚ²+0.068δₕ²=13.9γ_{sL}(1/(V_{L}^{1/3})) (formula 1)

As for the surface of the member sheet, the HSPs were determined by the same procedure. The results are shown in Table 2.

Further, the HSP distance (Ra) was calculated from the values of the HSPs on the adhesive sheet surface and the HSPs on the member sheet surface as measured above.

(Dynamic Viscoelasticity)

The mold release films on both surfaces were peeled off from the adhesive sheet prepared in each of Examples and Comparative Examples, and a plurality of the adhesive sheets was laminated to prepare a sheet having a thickness of approximately 0.8 mm. Then, the sheet was punched into a circle having a diameter of 8 mm and subjected to a measurement using a rheometer (DHR-2, manufactured by TA Instruments Japan Inc.) under the conditions where the adhesive jig was (8 mm parallel plate, the strain was 0.1%, the frequency was 1 Hz, the temperature was −70° C. to 100° C., and the temperature rise rate was 3° C./min, thereby obtaining a storage elastic modulus (G′), loss elastic modulus (G″), and loss tangent (tan δ) of the adhesive sheet. The results are shown in Table 2.

(Recovery Characteristics)

The adhesive sheet obtained in each of Examples and Comparative Examples was cut into a strip shape with a length of 70 mm and a width of 10 mm, and paper was attached to both sides of 10 mm×10 mm at both ends to serve as handles (the portion without the handles was a length of 50 mm and a width of 10 mm).

The handles were gripped and extended in the longitudinal direction until the length was four times the distance between the handles (200 mm), and then held for 10 minutes. Then, one handle was released to measure the length of the strip after the elapse of 20 minutes, and the adhesive sheet was evaluated as described below.

◯: The length between the handles after the test was 1.0 to 1.6 times the initial length.

x: The length between the handles after the test was more than 1.6 times the initial length.

<Preparation of Laminate>

The mold release film on one surface of the adhesive sheet prepared in each of Examples and Comparative Examples was peeled off, and a CPI film (50 μm) manufactured by Kolon Corporation was roll-adhered thereon. Then, the remaining mold release film was peeled off, and another CPI film (50 μm) manufactured by Kolon Corporation was adhered thereon. The laminate was subjected to an autoclave treatment (a gauge pressure of 0.2 MPa at 60° C. for 20 minutes) for finish-adhesion to obtain a laminate.

In Example II-4, a member sheet where the surface of the CPI manufactured by Kolon Corporation was subjected to an O₂ plasma treatment, was used as the member sheet.

(Dynamic Folding Test)

The resulting laminate was cut into a size of 40 mm×100 mm to obtain a sample for evaluating the dynamic folding test. The evaluation sample was repeatedly subjected to a U-shape bending in accordance with IEC 63715 using DLDMLH-FS manufactured by Yuasa System Co., Ltd. The test conditions were −30° C., frequency of 1 Hz, radius of curvature R of 3 mm, and 100,000 cycles; and the bendability was evaluated according to the following criteria.

◯: No change was observed in the appearance of the laminate after 100,000 times of folding.

x: A defect such as breakage, delamination, air bubbles, or foaming was observed in the laminate after 100,000 times of folding.

(Haze)

The laminate prepared by adhering the member sheet on both surfaces of the adhesive sheet was used as an evaluation sample. The haze value was measured in accordance with JIS K7136 using a haze meter (“NDH5000”, manufactured by Nippon Denshoku Industries Co. Ltd. The results are shown in Table 2.

(Adhesive Force)

A CPI film (50 μm) manufactured by Kolon Corporation serving as a member sheet was adhered to a SUS plate with a double-sided tape, and the mold release PET film was peeled off from one surface of the adhesive sheet to expose the adhesive sheet. Then, a polyethylene terephthalate film (“Diafoil S-100” having a thickness of 50 μm, manufactured by Mitsubishi Chemical Corporation) serving as a backing film was roll-pressed to the adhesive sheet using a hand roller. This was cut into a strip shape with a width of 25 mm and a length of 150 mm, and a CPI film (50 μm) manufactured by Kolon Corporation serving as a member sheet was roll-adhered to the adhesive surface exposed by peeling the remaining mold release film, by using a hand roller. The member sheet surface was adhered to a SUS plate with a double-sided tape to prepare a laminate composed of the SUS plate/double-sided tape/member sheet (CPI)/adhesive sheet/and backing film (PET). Then, the laminate was subjected to an autoclave treatment (a gauge pressure of 0.2 MPa at 60° C. for 20 minutes) for finish-adhesion to prepare a sample for measuring the adhesion force between the adhesive sheet and the member sheet.

The backing film was peeled off from the member sheet while pulling the backing film at an angle of 180° at a peel speed of 300 mm/min at 60° C. to measure the tensile strength using a load cell, and the 180-degree peel strength (N/25 mm) of the adhesive sheet with respect to the member sheet was measured. The results are shown in Table 2.

The results of the adhesive sheet formulation, the gel fraction of the adhesive sheet, the dynamic viscoelasticity of the adhesive sheet, the HSPs on the adhesive sheet surface, the HSP distance between the adhesive sheet and the member sheet, the adhesive force, and the dynamic folding test are shown in Table 2.

TABLE 2

| | | | | | | | | Comparative | Comparative |
|---|---|---|---|---|---|---|---|---|---|
| | | | Exam- | Exam- | Exam- | Exam- | Exam- | Exam- | Exam- |
| | | | ple II-1 | ple II-2 | ple II-3 | ple II-4 | ple II-5 | ple II-1 | ple II-2 |
| Adhe- | Formulations | (A-1) Acrylic polymer | 100 | | | | 100 | | 100 |
| sive | (solid content) | (A & B) Acrylic polymer-grafted | | 100 | 100 | | | | |
| sheet | (parts by weight) | polyurethane | | | | | | | |
| | | (B-1) Acryloyl group-terminated | 1.63 | | 6 | | | | |
| | | polyether-type polyurethane | | | | | | | |
| | | (B-2) OH group-terminated | | | | | 1.63 | 100 | |
| | | polyether-type polyurethane | | | | | | | |
| | | (C) Bifunctional urethane acrylate | | | | | | | 3 |
| | | (D) Esacure TZT | 3 | 3 | 3 | | | | 3 |
| | | (E) Coronate L | | | | | 0.3 | 0.3 | |
| | | (F) NACEM aluminum | | | | | 0.01 | 0.01 | |
| | | (G) Polycaprolactons-type | | | | | | | |
| | | polyurethane | | | | | | | |
| | Curing conditions | | UV | UV | UV | | 120° C., | 120° C., | UV |
| | | | 0.7 J/cm² | 0.7 J/cm² | 0.7 J/cm² | | 3 min | 3 min | 0.7 J/cm² |
| | Gel fraction (%) | | 72 | 73 | 77 | | 64 | 78 | 71 |
| | G′ (kPa) | −20° C. | 277 | 234 | 214 | | 288 | 803 | 252 |
| | | 25° C. | 46 | 46 | 50 | | 52 | 235 | 43 |
| | | 60° C. | 22 | 25 | 27 | | 30 | 100 | 19 |
| | Tg (° C.) | tanδ peak | −36.6 | −36.7 | −36.3 | | −37.5 | −44.5 | −37.2 |
| | HSPs | δd | 18.7 | 18.7 | 16.3 | | 16.6 | 19.8 | 16.8 |
| | (MPa^{0.5}) | δp | 6.9 | 6.9 | 12.0 | | 4.5 | 5.4 | 4.0 |
| | | δh | 5.5 | 5.9 | 12.0 | | 6.2 | 8.7 | 1.9 |
| | | δ total | 20.7 | 20.8 | 23.5 | | 18.3 | 22.3 | 17.4 |
| | Thickness (μm) | | 50 | 50 | 50 | | 50 | 50 | 50 |
| | Recovery | Holding time of 10 min at 4 times | 1.4 | 1.3 | 1.2 | | 1.6 | 2.1 | 1.9 |
| | (times) | extension | ◯ | ◯ | ◯ | | ◯ | X | X |
| | | → Length at the elapse of 20 min | | | | | | | |
| | | after releasing one end | | | | | | | |
| Lami- | Member sheet | Types | KOLON CPI 50 μm | | | | | | |
| nate | | Surface treatment | untreated | | | O₂ plasma | untreated | | |
| | | | | | | treatment | | | |
| | | Member sheet HSP δd (MPa^{0.5}) | 19.4 | | | 18.9 | 19.4 | | |
| | | Member sheet HSP δp (MPa^{0.5}) | 18.6 | | | 17.5 | 18.6 | | |
| | | Member sheet HSP δh (MPa^{0.5}) | 8.9 | | | 17.5 | 8.9 | | |
| | | Member sheet HSP δ total | 28.3 | | | 31.1 | 28.3 | | |
| | | (MPa^{0.5}) | | | | | | | |
| | HSP distance (Ra) | | 12.3 | 12.2 | 9.6 | 9.4 | 15.4 | 13.2 | 17.1 |
| | Haze (%) | | 0.6 | 0.6 | 0.6 | 0.6 | 1.1 | 0.6 | 0.6 |
| | | | ◯ | ◯ | ◯ | ◯ | Δ | ◯ | ◯ |
| | Adhesive force | 60° C., 0.3 m/min, 180° | 8.2 | 8.0 | 8.7 | 9.8 | 8.1 | 15.1 | 6.3 |
| | (N/25 mm) | | ◯ | ◯ | ◯ | ◯ | ◯ | ◯ | X |
| | Dynamic | R = 3, −30° C., 10k cycle | ◯ | ◯ | ◯ | ◯ | ◯ | X | ◯ |
| | folding | | | | | | | material | |
| | | | | | | | | breakage | |

As shown in Table 2, the formulations containing both the acrylic component segment and the urethane component segment (in Examples II-1 to II-5) achieved both the recovery characteristics and the adhesive force.

It was also confirmed that when the urethane component segment was contained, the δp and δh tended to be larger, and the HSP distance to the member sheet tended to be smaller.

It was suggested that the adhesive force at 60° C. was affected by both the G′ (60° C.) and the HSP distance. In particular, it was found that those containing the photopolymerizable urethane component, as in Examples II-1 to II-3, had a well-balanced performance including haze.

Meanwhile, in another test, when a polycaprolactone-type polyurethane (an oligomer composed of 47.8 wt. % of dicyclohexylmethane diisocyanate, 34.8 wt. % of polycaprolactone, 4.2 wt. % of neopentyl glycol, and 13.2 wt. % of 1,4-butanediol) was used instead of (B-1) in Example II-3, the urethane component segment such as polycaprolactone-type one and the acrylic component segment were incompatible, which worsened the haze. In contrast, the polyether-type urethane component segment and the acrylic component segment were observed to have a certain degree of compatibility, and based on the above results, it was found that the adhesive sheets and the laminates thereof were suitable for use in image display devices.

1. A flexible image display device member, having a configuration in which two flexible members are adhered together via an adhesive layer,
wherein the adhesive layer has a maximum value of a loss tangent (tan δ) obtained by dynamic viscoelasticity measurement in a shear mode at a frequency of 1 Hz being at −20° C. or lower, and in the Hansen solubility parameters (δd, δp, and δh) on the adhesive layer surface as measured by a contact angle method, the polar term δp is 2.0 MPa^{0.5} or more and the hydrogen bond term δh is 5.0 MPa^{0.5} or more.

2. The flexible image display device member according to claim 1, wherein the adhesive layer has a storage shear elastic modulus at 85° C. (G′ (85° C.)) obtained by dynamic viscoelasticity measurement in a shear mode at a frequency of 1 Hz being 0.01 MPa or more and 0.20 MPa or less.

3. The flexible image display device member according to claim 1 or 2, wherein the adhesive layer has a gel fraction being 55% or more.

4. The flexible image display device member according to any one of claims 1 to 3, wherein the adhesive layer comprises a compound having a urethane bond.

5. The flexible image display device member according to any one of claims 1 to 4, wherein the adhesive layer is formed from an adhesive agent comprising a graft polymer having a polymer component as a stem component and a polyurethane as a branch component.

6. The flexible image display device member according to claim 5, wherein the adhesive layer comprises a radical initiator.

7. The flexible image display device member according to any one of claims 1 to 6, wherein the adhesive layer is formed from an adhesive agent containing a hydroxyl group-terminated urethane prepolymer.

8. The flexible image display device member according to claim 1, wherein the adhesive layer comprises an adhesive agent having a urethane polymer chain and an acrylic polymer chain, the urethane polymer chain having a molecular chain having a urethane bond derived from a polyether polyol component and an isocyanate component (hereinafter referred to as “urethane component segment”), the acrylic polymer chain having a molecular chain derived from a (meth)acrylic acid alkyl ester component (hereinafter referred to as “acrylic component segment”).

9. The flexible image display device member according to claim 8, wherein the polyether polyol comprises a polyether glycol-derived component.

10. The flexible image display device member according to claim 9, wherein the mass ratio (% by mass) of the polyether glycol-derived component is larger than the mass ratio (% by mass) of the isocyanate-derived component.

11. The flexible image display device member according to any one of claims 8 to 10, wherein the urethane component segment and the acrylic component segment are bonded by a covalent bond.

12. The flexible image display device member according to any one of claims 8 to 11, wherein the adhesive agent comprises one or more of the following polymers (a) to (c):
(a) a block polymer in which the urethane component segment and the acrylic component segment constitute a main chain;
(b) a graft polymer in which either the urethane component segment or the acrylic component segment constitutes a main chain, and the other segment constitutes a side chain; and
(c) a crosslinked polymer in which either the urethane component segment or the acrylic component segment is crosslinked with the other segment.

13. The flexible image display device member according to any one of claims 8 to 11, wherein the adhesive agent is formed from an adhesive agent composition containing one or more of the following (d) and (e):
(d) an acrylic polymer and a polyether-type polyurethane; and
(e) a mixture of monomer components constituting acrylic polymers or a partially polymerized product thereof, and a polyether-type polyurethane.

14. The flexible image display device member according to claim 13, wherein the adhesive agent composition comprises a photo- or heat-curable adhesive agent composition that is cured by light or heat.

15. The flexible image display device member according to claim 13 or 14, wherein the polyether-type polyurethane has a (meth)acryloyl group or a hydroxyl group.

16. The flexible image display device member according to any one of claims 8 to 15, wherein the adhesive agent comprises an initiator and/or a crosslinking agent.

17. The flexible image display device member according to any one of claims 8 to 16, wherein the adhesive layer satisfies the following (I) and (II):
(I) a storage elastic modulus at −20° C. (G′ (−20° C.)) obtained by dynamic viscoelasticity measurement in a shear mode at a frequency of 1 Hz is 300 kPa or less; and
(II) a storage elastic modulus at 60° C. (G′ (60° C.)) obtained by dynamic viscoelasticity measurement in a shear mode at a frequency of 1 Hz is 10 kPa or more.

18. The flexible image display device member according to any one of claims 1 to 17, wherein an HSP distance (Ra) between the Hansen solubility parameters on the surface of at least one of the two flexible members and the Hansen solubility parameters on the surface of the adhesive layer is 17.0 or less.

19. The flexible image display device member according to any one of claims 1 to 18, wherein the adhesive layer has a 180-degree peel strength at a peel speed of 300 mm/min at 60° C. with respect to the flexible members being 10.0 N/25 mm or more.

20. The flexible image display device member according to any one of claims 1 to 19, wherein the flexible members comprise one or two or more resins selected from the group consisting of polyimide, epoxy resin, and polyester, as a main component resin.

21. A flexible image display device, comprising the flexible image display device member according to any one of claims 1 to 20.
